(19) United States
(12) Patent Application Publication
(10) Pub. No.: US 2006/0242270 A1
(43) Pub. Date: Oct. 26, 2006

(54) Isolation of user-mode device drivers

(75) Inventors: Mukund Sankaranarayan, Sammamish, WA (US); Chung Lang Dai, Redmond, WA (US); Stuart R. Patrick, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/111,016

(22) Filed: Apr. 21, 2005

(51) Int. Cl. G06F 15/177

(52) U.S. Cl. 709/220

(57) ABSTRACT

A host process for use in a user-mode device driver architecture is provided by the subject invention. The architecture includes a reflector, a driver manager and the host process which hosts and isolates one or more user-mode device driver(s). The user-mode device driver runs in the user-mode (UM) environment and has access to various UM services. The reflector resides in “kernel memory” (e.g., memory/resource(s) available to operating system) while the driver manager, host process and user mode device driver(s) are located in user space (e.g., memory/resource(s) available to user application(s)). The host process can include a host runtime component and a framework component. The host runtime component is responsible for building a driver stack object, and, locating/loading object(s) of a framework component. The host runtime component further includes a message handler that facilitates communication with the reflector and routes information to components of the host process.

### CROSS-REFERENCE TO RELATED APPLICATIONS

This application is related to co-pending U.S. utility application Ser. No. ______ (Attorney Docket reference MSFTP1000US) filed on Apr. _{—}, 2005, entitled PROTOCOL FOR COMMUNICATION WITH A USER-MODE DEVICE DRIVER, the entirety of which is incorporated herein by reference.

### TECHNICAL FIELD

The subject invention relates generally to user-mode device driver(s), and, more particularly to isolation of user-mode device driver(s).

### BACKGROUND OF THE INVENTION

A device driver (e.g., driver) is a software component (e.g., program) that permits a computer system to communicate with a particular device. Because the driver handles device specific features, an operating system is freed from the burden of having to understand and support needs of individual hardware devices. However, if a driver is problematic, the particular device controlled by the driver can fail to work properly and can even be completely inoperative. Additionally, a problematic driver can often cause an operating system to become unstable, create problems with a whole computer system and may even lead to system operation halting.

Computer systems today often employ a significant number of devices and corresponding device drivers. For example, a typical computer system can utilize devices such as sound cards, bus controllers, video capture devices, audio capture devices, universal serial bus devices, firewire controllers and devices, DVD drives, network cards, DSL modems, cable modems, LCD monitors, monitors, laser printers, ink jet printers, fax machines, scanners, digital cameras, digital video cameras and the like. Additionally, a single device can employ more than one device driver. For example, a typical 3-D video card can require numerous device drivers.

Most drivers are provided by third parties. A driver is added to the system, for example, whenever a user adds a new piece of hardware to their machine. Additionally drivers are frequently updated to fix problems/bugs in the driver, add performance and/or add other features. Most drivers run in the kernel of the operating system; which means if they do anything wrong it can be fatal to the running of the entire computer.

### SUMMARY OF THE INVENTION

The following presents a simplified summary of the subject invention in order to provide a basic understanding of some aspects of the subject invention. This summary is not an extensive overview of the subject invention. It is not intended to identify key/critical elements of the subject invention or to delineate the scope of the subject invention. Its sole purpose is to present some concepts of the subject invention in a simplified form as a prelude to the more detailed description that is presented later.

A host process component of a user-mode device driver architecture is provided by the subject invention. The architecture includes a reflector, a driver manager and a host process which hosts and isolates one or more user-mode device driver(s). A user-mode device driver is a component that abstracts hardware functionality. The user-mode device driver runs in the user-mode (UM) environment and has access to various UM services.

With the user-mode device driver(s) located in user-mode environment, as opposed to conventional device driver(s) which are executed in privileged kernel context (or “kernel mode”), instability problem(s) frequently experienced with conventional device driver(s) can be reduced. For example, conventional device drivers are easily capable of causing a fatal system error or crash, either through errors in programming, unplanned and/or unauthorized memory access, unexpected action from the device, and/or even malicious intent of the writer of the device driver. By moving the bulk of the programming for device control into the user context with the computer's application(s), the user-mode device driver generally does not cause system problems, because the user-mode device driver does not have access to the more-sensitive kernel context.

The reflector resides in “kernel memory” (e.g., memory/resource(s) available to operating system) while the driver manager, host process and user mode device driver(s) are located in user space (e.g., memory/resource(s) available to user application(s)). User-mode device driver(s) can be loaded, for example, when device(s) arrive and user-mode device driver(s) can be started and/or stopped with full plug-and-play (PnP) functionalities. In one example, the user-mode device driver(s) can be employed in a layered device driver model.

The reflector can redirect input/output (I/O) request(s) from application(s) to the user-mode device driver(s). Additionally, the reflector can perform security and/or parameter checking on I/O requests. The reflector can be at the top of a kernel device stack, thus allowing the reflector to intercept application I/O request(s) and forward them to the host process. Further, the reflector can forward plug-and-play message(s) from the operating system to the host process. This allows the user-mode device driver(s) to participate in the standard installation, loading and unloading of drivers afforded to convention kernel driver(s).

In accordance with an aspect of the subject invention a host process that includes a host runtime component and a framework component is provided. The host process hosts and isolates and user-mode device driver(s). The host runtime component is responsible for building a driver stack object, and, locating/loading object(s) of a framework component. The host runtime component further includes a message handler that facilitates communication with the reflector and routes information to components of the host process. The host runtime component can further include a user-mode I/O request packet(s) (IRPs) store and a user-mode file object.

The message handler can receive message(s) (e.g., LPC message(s)) from the reflector. Thereafter, the message handler can build user-mode IRPs that contain the message data (e.g., LPC message data) and route these IRPs to the device stack object. User Mode IRPs are objects that encapsulate the message data from the reflector.

The device stack object (DSO) receives IRPs from the message handler and routes them to framework object(s) of the framework component in a layered order. The device stack object represents a running instance of a user-mode driver stack. The DSO is responsible for constructing a driver stack based on information found in the registry, and route I/O and PnP messages to each user-mode device driver in the stack.

The framework component comprises one or more framework objects that are loaded the DSO when the DSO is first created. For each layer in the DSO, a framework object is first created. Then, based on information in the registry, a globally unique identifier that identifies a class object (e.g., CLSID) of an appropriate user-mode device driver is passed to the framework component which can then call CoCreateInstance to load the user-mode device driver.

Optionally, a user-mode file object can represent a specific I/O connection to the DSO. In one example, user-mode file object(s) come into existence when a CreateFile message on a device managed by the DSO is received. I/O request(s) can be targeted at user-mode file object(s) associated with the DSO.

Another aspect of the subject invention provides for a framework component that includes a driver object, a device object and/or a queue object which can expose a host process to the user-mode device driver(s). The framework component sits in between the user-mode device driver and the host runtime component, accepting requests from the host runtime component, and raising corresponding event(s) to driver(s).

The driver object, device object and queue object are a co-operating set of objects (“framework objects”). The state of these objects change when it receives an event and the driver can register with the framework component to be notified of these changes. Many of these events occur in arbitrary order and it is hard for the driver to synchronize its state and actions across these events. In this example, the framework component simplifies driver authoring by providing facilities that regulate the invocation of the driver callbacks.

In this example, each framework object can have method(s), property(ies) and/or event callback(s). The driver can communicate with framework objects via methods and properties, which are functions that a driver can call to perform an operation on the object, or to get or set an object property. The framework component can communicate with driver(s) via event callbacks, which are notifications that driver(s) can subscribe. Event callbacks are triggered as result of interesting state changes in the object.

The base object can be exposed to driver(s), and can provide basic functionality that is common across all framework object types (e.g., framework objects are derived from this root object). The driver object can similarly be exposed to driver(s) and can be the run time representation of the driver image loaded in the host process. The framework component can create a new driver object for each driver loaded in the driver host process.

Further, the device object can be exposed to driver(s) and can be the run time representation of device on the system. User-mode device driver(s) can register with the device object to get notifications when device(s) arrive and/or leave the system.

Additionally, queue object(s) can represent I/O queues, which are containers for I/O requests and can control the flow of requests into the user-mode device driver(s). The framework component can include default queue(s) and/or queue(s) created by the user-mode device driver(s). For queue(s) created by the user-mode device driver(s), a dispatch model can be specified, for example, sequential, parallel or upon request.

To the accomplishment of the foregoing and related ends, certain illustrative aspects of the subject invention are described herein in connection with the following description and the annexed drawings. These aspects are indicative, however, of but a few of the various ways in which the principles of the subject invention may be employed and the subject invention is intended to include all such aspects and their equivalents. Other advantages and novel features of the subject invention may become apparent from the following detailed description of the subject invention when considered in conjunction with the drawings.

### BRIEF DESCRIPTION OF THE DRAWINGS

FIG. 1 is a block diagram of a user-mode device driver architecture in accordance with an aspect of the subject invention.

FIG. 2 is a block diagram of a user-mode device driver architecture in accordance with an aspect of the subject invention.

FIG. 3 is a block diagram of an exemplary host process in accordance with an aspect of the subject invention.

FIG. 4 is a block diagram of an exemplary framework component in accordance with an aspect of the subject invention.

FIG. 5 is a flow chart of a method of adding a device in a user-mode device driver architecture in accordance with an aspect of the subject invention.

FIG. 6 illustrates an example operating environment in which the invention may function.

FIG. 7 illustrates an exemplary networking environment that can be employed in connection with the subject invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the subject invention.

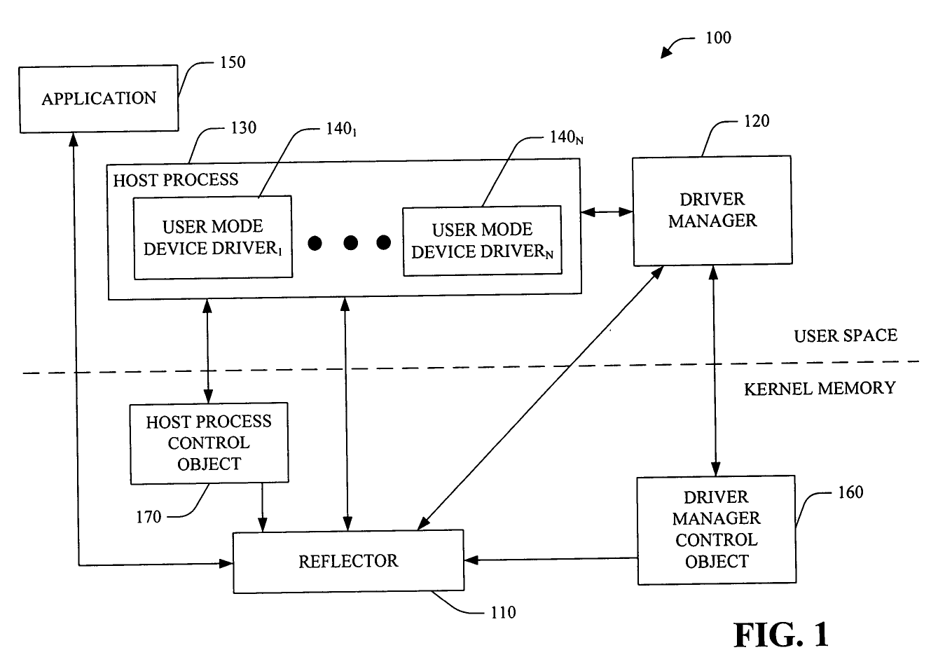

Referring to FIG. 1, a user-mode device driver architecture 100 in accordance with an aspect of the subject invention is illustrated. The architecture 100 includes a reflector 110, a driver manager 120 and a host process 130 which hosts and isolates one or more user-mode device driver(s) 140.

A user-mode device driver 140 is a component that abstracts hardware functionality. The user-mode device driver 140 runs in the user-mode (UM) environment and has access to various UM services.

The reflector 110 resides in “kernel memory” (e.g., memory/resource(s) available to operating system) while the driver manager 120, host process 130 and user mode device driver(s) 140 are located in user space (e.g., memory/resource(s) available to user application(s)). User-mode device driver(s) 140 can be loaded, for example, when device(s) arrive and user-mode device driver(s) 140 can be started and/or stopped with full plug-and-play (PnP) functionalities. In one example, the user-mode device driver(s) 140 can be employed in a layered device driver model.

Conventionally, device drivers are executed in privileged kernel context (or “kernel mode”) on a computer. As a result computer code which is responsible for controlling devices shares memory with the kernel of the operating system. Therefore, conventional device drivers are easily capable of causing a fatal system error or crash, either through errors in programming, unplanned and/or unauthorized memory access, unexpected action from the device, and/or even malicious intent of the writer of the device driver. By moving the bulk of the programming for device control into the user context (“user mode”) with the computer's application(s) 150, the user-mode device driver 140 generally does not cause system problems, because the user-mode device driver 140 does not have access to the more-sensitive kernel context.

The reflector 110 provides a secure, stable communication path for application(s) 150, the host process 130 and/or user-mode device driver(s) 140 to communicate with the operating system. In accordance with aspects of the subject invention, the reflector 110 can provide:
Security, to prevent interjection of malicious and/or unauthorized requests by rogue programs;
Robustness, so error(s) in programming of the user-mode device driver(s) 140 do not accidentally destabilize the operating system (e.g., kernel);
Reliability, to ensure that messages sent to and/or from the reflector 110 arrive;
Order, so that messages sent by application(s) 150, the host process 130 and/or user-mode device driver(s) 140 are received by the reflector 110 in the same order in which they were sent; and/or
Multiple communication channels, to allow multiple user-mode device drivers 140 to communicate with a single reflector 110.
   Reflector 110

In one example, the reflector 110 is a kernel mode driver that can redirect input/output (I/O) request(s) from application(s) 150 to the user-mode device driver(s) 140. Additionally, the reflector 110 can perform security and/or parameter checking on I/O requests. The reflector 110 can be at the top of a kernel device stack (not shown), thus allowing the reflector 110 to intercept application I/O request(s) and forward them to the host process 130. Further, the reflector 110 can forward plug-and-play message(s) from the operating system (not shown) to the host process 130. This allows the user-mode device driver(s) 140 to participate in the standard installation, loading and unloading of drivers afforded to conventional kernel driver(s).

For example, depending on the device class, an I/O request forwarded to the user-mode device driver(s) 140 can be resubmitted back to the reflector 110. In this case, the reflector 110 forwards the I/O request to a lower device stack for further processing. On completion, an I/O completion code can be returned back to the user-mode device driver(s) 140 which will return the I/O request back to the reflector 110. Thereafter, the reflector 110 can return the I/O completion code back to the requesting application 150.

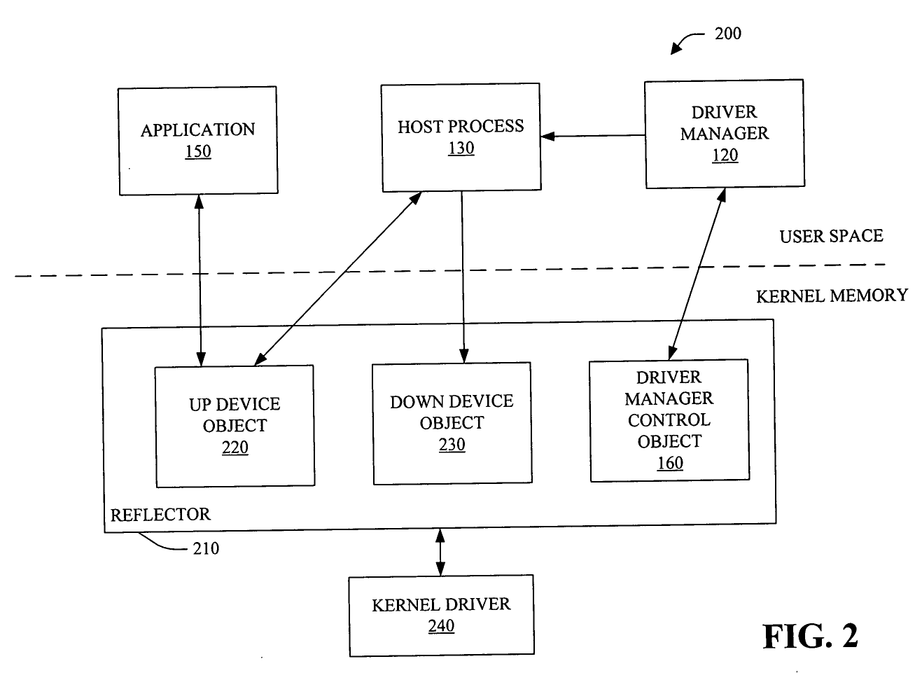

Referring briefly to FIG. 2, a user-mode device driver architecture 200 in accordance with an aspect of the subject invention is illustrated. In this example, a reflector 210 includes an up device object 220, a down device object 230 and the driver manager control object 160. As illustrated in FIG. 2, the reflector 200 is central to the architecture 200 as the other components including the application 150, host process 130 and the driver manager 120 communicate with the reflector 200.

In this example, the reflector 210 is a kernel filter driver and is at the top of kernel device stack. This allows the reflector 210 to intercept application I/O requests and forward them to the host process 130. In addition to the application requests, the reflector 210 also forwards PnP message(s) received from the operating system to the host process 130. This allows the user-mode device driver(s) 140 to participate in the standard installation, loading and unloading of drivers afforded to kernel drivers.

It is often necessary for the user-mode device driver(s) 140 to communicate with kernel driver(s) 240 below the reflector 210, for example, in response to an application 150 I/O request forwarded from the reflector 210. Since this communication happens via the reflector 210, the reflector 210 needs to distinguish application 150 I/O requests from user-mode device driver 140 I/O requests to the kernel driver 240.

In this example, the reflector 210 accomplishes this by creating two device objects for each device stack (also referred to herein as “DevNode”)—one device object for application(s) 150 to send request(s) to the user-mode device driver(s) 140, which is referred to as the up device object 220. The down device object 230 enables the user-mode device driver(s) 140 to send request(s) to the kernel driver(s) 240 below the reflector 210.

Driver Manager 120

Referring back to FIG. 1, the driver manager 120 is the reflector 110's “extension” into the user space. The driver manager 120 can create the host process 130 in response to a request from the reflector 110 (e.g., when a plug-and-play subsystem initializes a device). The driver manager 120 can run as a service of a computer system's operating system. Additionally, the driver manager 120 can track information on host process(es) 130. Finally, the driver manager 120 can destroy the host process 130 (e.g., in response to a request from the reflector 110).

For example, when the reflector 110 is loaded, its standard driver entry function can be called. During such time, the reflector 110 can communicate with the driver manager 120, for example, using a particular user-mode driver framework (UMDF) advanced local procedure call (ALPC) library. During the connection process, the reflector 110 can provide a security identifier (SID) of the driver manager 120 for authentication. In this example, if the reflector 110 fails to create an IPC connection with the driver manager 120, the reflector 110 fails its driver entry function and unloads from the system (e.g., device not enabled when any one of its drivers fails its driver entry routine).

The communication channel between reflector 110 and the driver manager 120 can be maintained (e.g., through the lifetime of the reflector 110). In one example, if the communication is broken for any reason, the reflector 110 can tear down all device stacks and unloads the host process 130 from the system.

The driver manager 120 can employ a driver manager control object 160 to send request(s) to the reflector 110 in the context of the driver manager 120. As noted previously, in one example, communication between the reflector 110 and the driver manager 120 is generally effected via a UMDF ALPC library. However, the UMDF ALPC library delivers message(s) in the receiver's context (e.g., sender(s)' process specific data becomes invalid).

Access to the driver manager control object 160 can be controlled (e.g., via an access control list) with the SID of the driver manager 120. Thus, request(s) must come only from the driver manager 120.

In one example, communication between the reflector 110 and the driver manager 120 is performed via inter process communication (IPC) message(s) (e.g., with a standard timeout value). Exemplary IPC messages include: process management—control object name, process management—open process, process management—close process, and, I/O control. In addition to a process handle, the I/O control message can include:
PDO name of the device for which the host process 130 is created.
Host process timeout value which is the amount of time the reflector 110 shall wait for each PnP and power request sent to the host process 130.
Name of a local procedure call (LPC) port created by the host process 130 with which the reflector 110 to communicate.
Handle to the host process 130. The reflector 110 can map this handle to a kernel process pointer and take a reference on this pointer in order to make sure the process is not unloaded. When the reflector 110 connects to the host process 130 via the given LPC port name, the reflector 110 can validate that the LPC server process ID matches the process ID given in the host process pointer.

In one example, when the driver manager 120 first starts, the following are performed:
Configuration parameters are loaded from the registry.
UMDF tracing is enabled, if necessary.
A linked list to track host process(es) is initialized (Process List).
A linked list to track device node(s) is initialized (DevNode List).
A linked list to track service key object(s) is initialized (Service Key List).
A driver manager control object 160 (used to communicate with the reflector 110) is created.
The driver manager 120 beings listening on its ALPC connection for reflector 110 messages.

Thereafter, the driver manager 120 can wait for a message from the reflector 110 to create a host process 130 (e.g., “open process” message). In response to receipt of the host process message, the driver manager 120 can create a new device node (DevNode), for example, using the PDO name in the message. This new device node can be inserted into the DevNode List.

The DevNode can initialize itself with registry information containing a list of drivers to load along with a preferred host process GUID. The driver manager 120 can next create a host process 130, for example, with a Create Process call with a path to the host process 130 executable, host process GUID and/or a port name the host process 130 to assign to the ALPC port it will open when it initializes.

The driver manager 120 then attempts to connect to the host process 130's ALPC port. If this connection times out, or the host process 130 terminates unexpectedly an error is returned. If the connection is successful, the driver manager 120 forwards the host process 130 port name and timeout value to the reflector 110. The reflector 110 connects to the new host process 130 and begins building the driver stack.

In response to a “close process” message from the reflector 110, the driver manager 120 can search the DevNode list for the DevNode matching the PDO name in the Close Process message. Thereafter, the reference(s) on the particular DevNode are released which initiates clean-up of the associated host process list. As part of the destruction process, an “exit process” message is sent to the host process 130. The driver manager 120 can further wait on the handle to the host process 130 and expect it to be signaled when the host process 130 shuts down. However, if after specified time, the host process 130 has not ended, a Terminate Process function can be called to end the host process 130.

Additionally, the driver manager 120 can be shut down upon request (e.g., of the service control manager (SCM)), for example, when the operating system is shutting down. The driver manager 120 can perform the following when it shuts down:
When the SCM sends the SERVICE_CONTROL_STOP control code, the driver manager(s) 120 can call SetEvent on an event it created at start-up time.
When the termination event is signaled, a pre-registered callback routine can execute and call release on the driver manager 120.
The driver manager 120 can shut down and clean-up any DevNode and/or Process objects in their respective lists.
Finally, the ALPC port shared with the reflector 110 can be closed.
   Host Process 130

A user-mode device driver 140 is instantiated by the host process 130 which manages communication with the reflector 110, for example, via secure channel(s). The host process 130 thus provides the runtime environment for the user-mode device driver(s) 140. In one example, four channels can be employed—two channels for input and output, one channel for signaling device arrival/removal (“plug and play event(s)”), and, one channel for out-of band cancellation of message(s) already sent. In another example, more channels are used for each of these types of communication. In yet another example, one channel is employed.

In one example, the reflector 110 and the host process 130 communicate via IPC message(s) which can map, for example, to a system event (e.g., add device and/or PnP start device) that the reflector 110 receives. IPC message(s) sent to the host process 130 can be asynchronous, for example, with a device specific timeout value. Exemplary IPC messages between the reflector 110 and the host process 130 can include add device, and PnP and Power I/O Request Packets. Exemplary messages based on PnP and/or Power IRPs include start device message, query remove device message, remove device message, cancel remove device message, stop device message, query stop device message, cancel stop device message, query device relations message, query interface message, query capabilities message, query resources message, query resources requirements message, query device text message, query filter resource requirements message, read configuration message, write configuration message, eject message, set lock message, query ID message, query PNP device state message, query bus information message, device usage notification message, surprise removal message, query proximity domain message, wait wake message, power sequence message, set power message, and/or, query power message. Additionally, file I/O request(s) can be exchanged between the host process 130 and the reflector 110, for example, create message, cleanup message, close message, read message, write message, I/O control message, and/or I/O cancellation message.

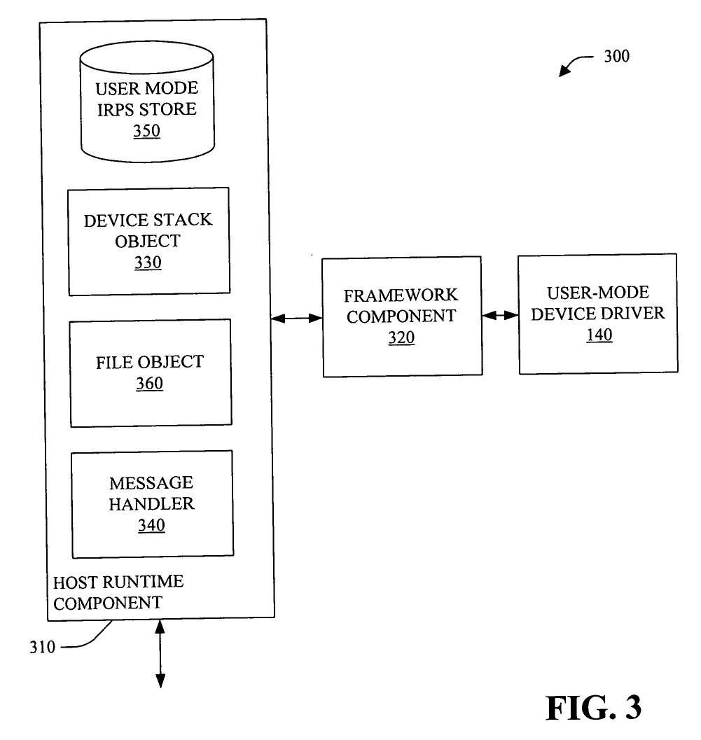

Turning to FIG. 3, an exemplary host process 300 in accordance with an aspect of the subject invention is illustrated. The host process 300 includes a host runtime component 310 and a framework component 320. The host process 300 host and isolates and user-mode device driver(s) 140.

The host runtime component 310 is responsible for building a driver stack object 330, and, locating/loading object(s) of a framework component 320. The host runtime component 310 further includes a message handler 340 that facilitates communication with the reflector 110 and routes information to components of the host process 300. The host runtime component 320 can further include a user-mode IRPs store 350 and a user-mode file object 360.

For example, when a Plug and Play system detects the arrival of a device managed by a user mode device driver 140, the reflector 110 can be loaded. The reflector 110 requests the driver manager 120 to locate (or create) a host process 300 that will host the user mode driver stack object 330 for the device. Once the host process 300 is created, the reflector 110 establishes communication with it, for example, via an ALPC port. The reflector 110 then instructs the host process 300 to locate and build the driver stack object 330 necessary for proper operation of the device. Subsequent PnP traffic and I/O traffic targeted at the device are routed by the reflector 110 into the host process 300. Additionally, when the device is removed from the system, the reflector 110 sends the necessary messages to the host process 300 to cancel outstanding I/O and then initiates an orderly host process 300 shutdown.

The host runtime component 310 can include state, for example:
A mode variable that indicates the current lifetime phase of the process, for example, starting, running and shutting down. Initially, the system is considered in the starting state.
A set of device stack objects which is initially empty. As device stack objects are created this set is updated accordingly.
A set of file objects is initially empty. As file objects created this set is updated accordingly.
A set if IRP objects which is initially empty. As IRP objects are created this set is updated accordingly.
A variable containing the count of calls to the AddDevice action.
A variable containing the count of calls to the CreateFile action.
A variable containing the count of I/O request actions.

The message handler 340 can receive message(s) (e.g., ALPC message(s)) from the reflector 110. Thereafter, the message handler 340 can build user-mode IRPs that contain the message data (e.g., ALPC message data) and route these IRPs to the device stack object 330.

User Mode IRPs are objects that encapsulate the message data from the reflector 110. In one example, depending on the data, different types of IRPs can be constructed. For example, the IRP for the start device PnP event differs from DeviceIoControl IRP. However, in this example, all IRPs derive from a common base class that contains object lifetime code and also the code necessary to add and/or remove IRPs to/from the user-mode IRPs store (e.g., global UM IRP list).

The device stack object 330 (DSO) receives IRPs from the message handler 340 and routes them to framework object(s) of the framework component 320 in a layered order (as discussed below). Generally, there is one instance of the DSO 330 for each running user-mode device.

The device stack object 330 represents a running instance of a user-mode driver stack. The DSO 330 is responsible for constructing a driver stack based on information found in the registry, and route I/O and PnP messages to each user-mode device driver in the stack. In one example, the DSO 330 can be modeled with the following variables:
A state variable called LoadState which tracks the life time of the DSO 330.
A state variable called RunState which tracks the DSO 330's ability to accept I/O requests.
An initially empty set of user-mode file objects 360.
A count of uncompleted PnP requests submitted to the DSO 330. This variable is used to serialize the processing of PnP requests within the DSO 330.

In this example, logically, the user-mode driver stack sits between the reflector 110 and the kernel mode driver(s) 340 beneath it. Kernel mode IRPs that are dispatched by the I/O Manager (not shown) to the reflector 110 are first marshaled into user-mode via ALPC and become UM IRPs. It is the DSO 330's responsibility to present the UM IRP to the user-mode driver stack in the correct driver order. When the request object is completed by the bottom most user mode driver, the UM IRP is “completed” which causes a reply to be sent to the reflector 110, which then continues forwarding the kernel mode IRP down the kernel mode stack.

When the kernel mode IRP is completed, it conceptually moves back “up” the stack using a completion routine mechanism. When the reflector 110 receives the IRP moving up the stack, it must again marshal the IRP into user-mode and notify the DSO 330 that the resulting UM IRP needs to be dispatched to the user-mode stack in a bottom up fashion.

Thus, in this example, the ALPC message received from the reflector 110 can include a “direction” flag indicating the up or down direction of the underlying kernel mode IRP. Also, the reflector 110 can retain a pointer to the UM IRP initially created on the “down” pass and present it during the “up” pass. Thus, facilitating the host process 300 to locate the correct UM IRP and execute any associated completion handlers.

Next, the framework component 320 comprises one or more framework objects that are loaded the DSO 330 when the DSO 330 is first created. For each layer in the DSO 330, a framework object is first created. Then, based on information in the registry, a globally unique identifier that identifies a class object (e.g., CLSID) of an appropriate user-mode device driver 140 is passed to the framework component 320 which can then call CoCreateInstance to load the user-mode device driver 140.

Next, a user-mode file object 360 represents a specific I/O connection to the DSO 330. In one example, user-mode file object(s) 360 come into existence when a CreateFile message on a device managed by the DSO 330 is received. I/O request(s) can be targeted at user-mode file object(s) 360 associated with the DSO 330. For example, user-mode file object(s) 360 can be modeled with the following variables:
A state variable indicating the life time phase of the user-mode file object 360, for example, creating, created, closing and/or closed.
A pointer to a DSO associated with a given file object 360.
A count of uncompleted I/O requests for the file object 360, for example, used to synchronize the RemoveDevice PnP event with any outstanding I/O requests.

Next, the user-mode file object 360 can be created when an application calls CreateFile on a user-mode device. The UM file object 360 can represent an I/O connection to the device, that is, a UM file object 360 is an opened instance on a DSO 330. When the reflector 110 sends an I/O request to the host process 300, it identifies a previously opened UM file object 360 as the target of those I/O requests.

In one example, the reflector 110 holds a reference on both the DSO 330 and any UM file objects 360. The UM file objects 360 hold a reference on their associated DSO 330. The DSO 330 holds a reference on any framework objects that it has loaded and the framework objects hold two way references on the UM device driver(s) 140.

In one example, the host runtime component 310 can include a plurality of threads to asynchronously handle request types, for example:
I/O requests
I/O cancellation requests
I/O completion requests
PnP requests

Operational sequences of the host process 300 include start-up, shutdown, PnP events, and, I/O requests:

Start-Up

In one example, as noted previously, the driver manager 120 calls CreateProcess to create the host process 300. Thereafter, the main( ) thread of the host process 300 runs and creates the message handler 340. The message handler 340 establishes communication with the reflector 110 via the ALPC port (as part of initialization, a thread is created which services the ALPC port). The host process 300's main thread then invokes the message handler 340's Run( ) method. This method simply waits on an event which, when triggered, causes the Run( ) method to exit and the host process 300 to shut down.

Shutdown

The message handler 340 receives an ExitProcess ALPC message. The message handler 340 sets the event being waited on by the host process's main thread and then sends a successful reply to the reflector 110.

PnP Events

Exemplary PnP Events include, AddDevice, StartDevice, Query Remove Device, and, Remove Device.

Add Device

In response to receiving an ALPC AddDevice message from the reflector 110, the message handler creates an AddDevice UM IRP which encapsulates the ALPC message along with a reply message. The UM RIP is inserted into the user-mode IRP store 350. The message handler 340 can then invoke its OnAddDevice( ) method passing in the UM IRP.

OnAddDevice gets the PDO name from the message and uses it to find the device hardware key. From this key, driver configuration data is obtained. Thereafter, a DSO 330 is created and initialized with the driver configuration data. A pointer to the DSO 330 is stored in the reply message of the IRP. When the IRP is completed the reply message will be sent back to the reflector 110.

The DSO 330 builds the driver stack by calling CoCreateInstance to create the Framework object(s). The DSO 330 then instructs each framework object to load its associated driver. Once each framework object has loaded and initialized its driver, the DSO 330 completes the “AddDevice” IRP. When the AddDevice IRP is completed, it is removed from the user-mode IRPs store 350 and the ALPC reply message is sent back to the reflector 110.

Start Device

Upon receiving a StartDevice ALPC message, the message handler 340 can create a “StartDevice” IRP which encapsulates the ALPC message data along with a reply message. When the “StartDevice” IRP is created, it identifies which DSO 330 needs starting by retrieving the DSO pointer from the ALPC message. Thereafter, the “StartDevice” IRP is inserted into user-mode IRPs store 350 and the Dispatch( ) method on the “StartDevice” IRP is invoked which calls the DSO's OnStartDevice method.

Thereafter, the DSO 330's OnStartDevice method calls the framework(s) StartDevice method passing the IRP. When the device has been started, the driver will complete the “StartDevice” IRP. When the “StartDevice” IRP is completed, it is removed from the user-mode IRPs store 350 and the ALPC reply message is sent back to the reflector 110.

Query Remove Device

In response to receiving a QueryRemoveDevice ALPC message, the message handler 340, creates a “QueryRemove” IRP which encapsulates the ALPC message data along with a reply message. When the “QueryRemove” IRP is created, it identifies which DSO 330 needs to be queried for removal by retrieving the DSO pointer from the ALPC message.

Thereafter, the “QueryRemove” IRP is inserted into the user-mode IRPs store 350. The Dispatch( ) method on the “QueryRemove” IRP is invoked which calls the DSO 330's OnQueryRemoveDevice method. The DSO 330's OnQueryRemoveDevice method calls the framework(s) QueryRemoveDevice method passing the IRP.

When the driver(s) have finished their query remove processing, the “QueryRemoveDevice” IRP will be completed. When the “QueryRemove” IRP is completed, it is removed from the user-mode IRPs store 350 and the ALPC reply message is sent back to the reflector 110.

Remove Device

After receiving a RemoveDevice ALPC message, the message handler can create a “Remove” IRP which encapsulates the ALPC message data along with a reply message. When the “Remove” IRP is created, it identifies which DSO 330 needs to be removed by retrieving the DSO pointer from the ALPC message. The “Remove” IRP can be inserted into the user-mode IRPs store 350. Thereafter, the Dispatch( ) method on the “Remove” IRP is invoked which calls the DSO 330's OnRemoveDevice method.

The DSO 330's OnRemoveDevice method calls the framework(s) RemoveDevice method passing the IRP. When the driver(s) have finished their remove processing, the “RemoveDevice” IRP will be completed. When the “Remove” IRP is completed, it is removed from the user-mode IRPs store 350 and the ALPC reply message is sent back to the reflector 110.

I/O Requests

I/O requests include Create File, Device I/O control, Read, Write, Cleanup, and, Close File.

Create File

After receiving a CreateFile ALPC message, the message handler 340 can create a “Create” IRP which encapsulates the ALPC message data along with a reply message. When the “Create” IRP is created, it identifies the targeted DSO 330 by retrieving the pointer to the DSO 330 from the ALPC message. The “Create” IRP is inserted into the user-mode IRPs store 350 and the Dispatch( ) method on the “Create” IRP is invoked which calls the DSO 330's OnCreateFile method.

The DSO 330 creates a “Host” user-mode file object 360 and stores a pointer to it in the “Create” IRP. The DSO 330 then calls the framework's CreateFile method passing in the IRP.

When the device has completed its CreateFile processing, it will complete the “Create” IRP. When the “Create” IRP is completed, the resulting “Framework” file object is stored into the “Host” user-mode file object 360. The “Create” IRP is removed from the user-mode IRPs store 350, and the ALPC reply message is sent back to the reflector 110.

Device I/O Control

In response to receiving a DeviceIoControl ALPC message from the reflector 110, the message handler 340 can create a “DeviceIoControl” IRP which encapsulates which encapsulates the ALPC message data along with a reply message. When the “DeviceIoControl” IRP is created, it identifies the target file object 360 by retrieving the “Host” file object pointer from the ALPC message. The “DeviceIoControl” IRP is inserted into the user-mode IRPs store 350 and the Dispatch( ) method on the “DeviceIoControl” IRP is invoked which extracts the “Framework” file object 360 from the “Host” file object and then calls the DSO 330's OnDeviceIoControl method. The DSO 330 calls the framework's DeviceIoControl method.

When the driver completes its DeviceIoControl processing, it will complete the “DeviceIoControl” IRP. When the “DeviceIoControl” IRP is completed, it is removed from the user-mode IRPs store 350 and the ALPC reply message is sent back to the reflector 110.

Read

After receiving a Read ALPC message, the message handler 340 creates a “Read” IRP which encapsulates the ALPC message data along with a reply message. When the “Read” IRP is created, it identifies the target file object 360 by retrieving the “Host” file object pointer from the ALPC message. Thereafter, the “Read” IRP is inserted into the user-mode IRPs store 350 and the Dispatch( ) method on the “Read” IRP is invoked which extracts the “Framework” file object 360 from the “Host” file object 360 and then calls the DSO 330's OnRead method. The DSO 330 calls the framework 320's Read method.

When the driver 140 completes its Read processing, it will complete the “Read” IRP. When the “Read” IRP is completed, it is removed from the user-mode IRPs store 350 and the ALPC reply message is sent back to the reflector 110.

Write

In response to receiving a Write ALPC message, the message handler 340 can create a “Write” IRP which encapsulates the ALPC message data along with a reply message. When the “Write” IRP is created, it identifies the target file object 360 by retrieving the “Host” file object pointer from the ALPC message. The “Write” IRP is inserted into the user-mode IRPs store 350, and, the Dispatch( ) method on the “Write” IRP is invoked which extracts the “Framework” file object 360 from the “Host” file object 360 and then calls the DSO 330's OnWrite method. The DSO 330 calls the framework 320's Write method.

When the driver 140 completes its Write processing, it will complete the “Write” IRP. When the “Write” IRP is completed, it is removed from the user-mode IRPs store 350 and the ALPC reply message is sent back to the reflector 110.

Cleanup

In response to receiving a Cleanup ALPC message, the message handler 340 can create a “Cleanup” IRP which encapsulates the ALPC message along with a reply message. When the “Cleanup” IRP is created, it identifies the target handle on the framework object associated with the target device. The “Cleanup” IRP is inserted into the user-mode IRPs store 350 and the Dispatch( ) method on the “Cleanup” IRP is invoked which extracts the “Framework” file object 360 from the “Host” file object 360 and then calls the DSO 330's OnCleanup method.

Close File

Upon receiving a CloseFile ALPC message, the message handler 340 creates a “Close” IRP which encapsulates the ALPC message data along with a reply message. When the “Close” IRP is created, it identifies the target file object 360 by retrieving the “Host” file object pointer from the ALPC message. The “Close” IRP is inserted into the user-mode IRPs store 350 and the Dispatch( ) method on the “Close” IRP is invoked which extracts the “Framework” file object 360 from the “Host” file object 360 and then calls the DSO 330's OnClose method. Thereafter, the DSO 330 calls the framework 320's CloseFile method.

When the driver 140 completes its CloseFile processing, it completes the “Close” IRP. When the “Close” IRP is completed, it is removed from the user-mode IRPs store 350 and the ALPC reply message is sent back to the reflector 110.

Additionally, the final reference count on the “Host” file object 360 is released which causes its deletion. As part of the “Host” file object 360 deletion, the final reference to the “Framework” file object 360 is released which causes it to be deleted.

User-Mode IRP Objects

In one example, User mode IRP objects are modeled using a class inheritance scheme including a base class called IrpObject and IRP specific derived classes. The base IrpObject can contain a life-time state variable whose value can be either Created, or Completed.

Device IRP Types (PnP)

The Add, Remove and Start IRPs control the overall device state. AddIrp causes a new DSO 330 to be created and RemoveIrp destroys it. StartIrp tells the device to ready itself for subsequent I/O requests. In this example, all of these IRPs derive from a base class called DeviceIrp (which in turn derives from the base class IrpObject). The DeviceIrp class maintains a pointer to the device's DSO 330. Each time a specifc DeviceIrp is created, the model assumes the Irp is being submitted to the DSO 330. The DSO 330's load or run state is updated accordingly (depending on the Irp type), and the pending PnP IRP count is incremented. When the IRP is completed, this pending PnP IRP count is decremented and the DSO 330's load or run state is again updated accordingly. For example:
The StartDevice action can be triggered on a DSO 330 when the required constraints have been achieved.
The StartDevice action can be create a StartIrp. This IRP's constructor increments the pending PnP IRP count and sets the DSO 330's run state to Starting.
At a later time, the CompleteStartIrp action is triggered which decrements the PnP IRP count and sets the DSO 330's run state to Started.
   File IRP Types (I/O)

In this example, I/O requests are represented with the CreateFile, ReadFile, WriteFile, DeviceIoControl and CloseFile IRPs. The CreateFile IRP causes the DSO 330 to generate a file object 360 and the CloseFile IRP destroys it. The other IRPs move data in and out of the device. From a modeling perspective these IRPs do not affect the device state but the count of uncompleted I/O IRPs does affect the requirements necessary to trigger the PnP RemoveDevice action. RemoveDevice is triggered only when all file objects 360 associated with the device have been closed, and file objects 360 cannot be closed until all I/O requests associated with them have been completed.

Additionally, in this example, all I/O IRPs derive from a base class called FileIrp which contains a pointer to a file object 360 and a count of pending I/O requests against that file object 360. The pending request count increases and decreases as I/O requests are created and completed. No serialization of I/O requests is enforced (i.e. there can be multiple I/O requests active against a given file object).

PnP Actions

PnP actions can cause the creation, activation and deletion of DSO 330's. To serialize PnP actions, the DSO 330 can include a variable called PendingPnpIrpCount. This variable is incremented each time a PnP action is triggered and decremented when the resulting PnP IRP is completed. In this example, all PnP actions require PendingPnPIrpCount to be zero before they can be triggered. Thus, all PnP actions are serialized.

AddDevice

When the reflector 110 initiates AddDevice, the host process 300 responds by creating a DSO 330 which in turn loads a stack of Framework objects 320. The AddDevice action creates a DSO 330 along with AddIrp object. As discuss previously, creation of the AddIrp object transitions the DSO 330 into the Adding state and completion of that IRP will transition the DSO into the Added state.

RemoveDevice

When the reflector 110 desires to remove a driver stack, it invokes the RemoveDevice action on a specific DSO 330. This action creates a RemoveIrp which when later completed, will transition the DSO 330 into the Removed state.

StartDevice

Once a DSO 330 is loaded, the reflector 110 can invoke the StartDevice action on it. This action creates a StartIrp which when later completed, will transition the DSO 330 into the Started state.

I/O Actions

CreateFile

In this example, the CreateFile action can only run when the DSO 330's load and run states are Added and Started, respectively. This action creates a file object 360 and associates it with a particular DSO 330 by adding it to the DSO 330's set of file objects. The CreateFile action next allocates a CreateFileIrp and associates it with the newly created file object 360 which causes the file object's state to be set to Creating. Later, when the IRP is completed, the file object's state is transitioned to Created.

Cleanup

In this example, the Cleanup action can only run against file object(s) 360 that are in the Created state. This action creates a CleanupIrp and associates it with a given framework object whose state is left unchanged. When the IRP is later completed, the object can be removed from the DSO 330.

CloseFile

In this example, the CloseFile action can only run against file object(s) 360 that are in the Created state. This action creates a CloseFileIrp and associates it with a given file object 360 which causes the file object's state to be set to Closing. Later, when the IRP is completed, the file object's state can be transitioned to Closed.

ReadFile

In this example, the ReadFile action can only run against file object(s) 360 that are in the Created state. This action creates a ReadFileIrp and associates it with a given file object 360 whose state is left unchanged. When the IRP is later completed, the file object's state is left unchanged as well.

WriteFile

In this example, the WriteFile action can only run against file object(s) 360 that are in the Created state. This action creates a WriteFileIrp and associates it with a given file object 360 whose state is left unchanged. When the IRP is later completed, the file object's state is left unchanged as well.

DeviceIoControl

Again, in this example, the DeviceIoControl action can only run against file object(s) 360 that are in the Created state. This action creates a DeviceIoControlIrp and associates it with a given file object 360 whose state is left unchanged. When the IRP is later completed, the file object's state is left unchanged as well.

IRP Completions

IRP Completions Include:

| | |
|---|---|
| CompleteAddIrp | This action completes the AddIrp and |
| | transitions the DSO 330 into the Added |
| | state. |
| CompleteRemoveIrp | This action completes the RemoveIrp and |
| | transitions the DSO 330 into the Removed |
| | state. |
| CompleteStartIrp | This action completes the StartIrp and |
| | transitions the DSO 330 into the Started |
| | state. |
| CompleteCreateFileIrp | This action completes the CreateFileIrp |
| | and transitions the file object 360 the |
| | Created state. The file object's pending |
| | I/O count is decremented. |
| CompleteCloseFileIrp | This action completes the CloseFileIrp and |
| | transitions the file object 360 to the Closed |
| | state. It also disassociates the file object |
| | 360 from the DSO 330 by removing it |
| | from the DSO 330's file object set. The |
| | file object's pending I/O count is |
| | decremented. |
| CompleteReadIrp | This action completes the ReadIrp and |
| | decrements the pending file I/O count. |
| CompleteWriteIrp | This action completes the WriteIrp and |
| | decrements the pending file I/O count. |
| CompleteDeviceIoControlIrp | This action completes the |
| | DeviceIoControlIrp and decrements the |
| | pending file I/O count. |
| CompleteCleanupIrp | This action completes the CleanupIrp and |
| | removes the object from the DSO 330. |

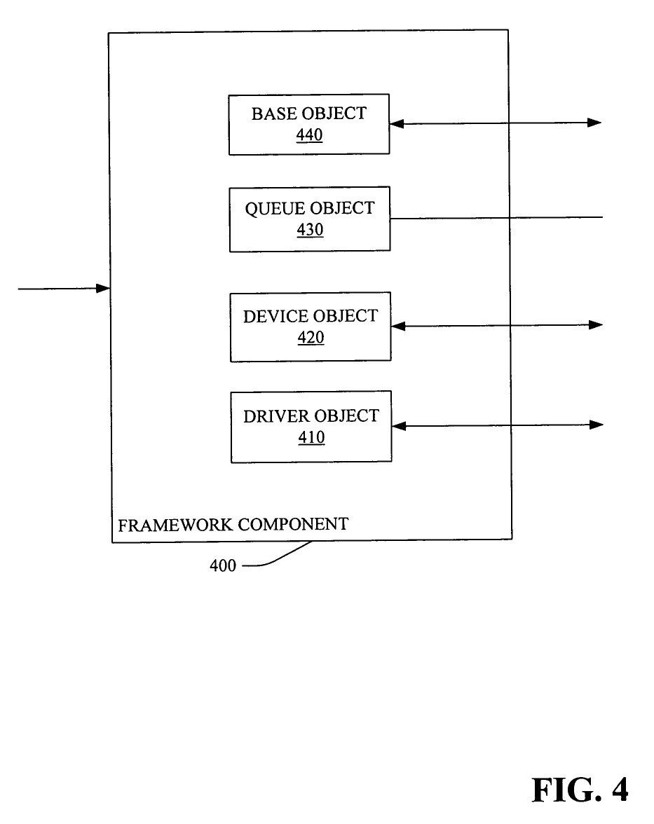

Referring next to FIG. 4, an exemplary framework component 400 in accordance with an aspect of the subject invention is illustrated. The framework component 440 includes a driver object 410, a device object 420 and/or a queue object 430 which can expose a host process to the user-mode device driver(s) 140.

Generally, user-mode device driver(s) 140 are essentially state machines and are event driven. There are two types of events that drive and control the driver: (a) system events like device arrival, removal, system shutdown, etc, and (b) application I/O events like CreateFile and ReadFile calls from an application. In this example, the framework component 400 capitalizes on this, building the event driven nature of driver 140 into its interface(s). The framework component 400 sits in between the driver 140 and the host runtime component 310, accepting requests from the host runtime component, and raising corresponding event(s) to driver(s) 140.

The driver object 410, device object 420 and queue object 430 are a co-operating set of objects (“framework objects”). The state of these objects change when it receives an event and the driver 140 can register with the framework component 400 to be notified of these changes. Many of these events occur in arbitrary order and it is hard for the driver 140 to synchronize its state and actions across these events. In this example, the framework component 400 simplifies driver authoring by providing facilities that regulate the invocation of the driver callbacks.

The driver object 410, device object 420 and queue object 430 collectively provide a series of objects exposed to the driver 140. The driver object 410 and the device object 420 can be created by the framework component 400 in response to application triggered actions, such as an I/O request. The queue object 430 can be created in response to a request from the driver 140.

In this example, each framework object can have method(s), property(ies) and/or event callback(s). The driver 140 can communicate with framework objects via methods and properties, which are functions that a driver 140 can call to perform an operation on the object, or to get or set an object property. The framework component 400 can communicate with driver(s) 140 via event callbacks, which are notifications that driver(s) 140 can subscribe. Event callbacks are triggered as result of interesting state changes in the object.

For example, with respect to a queue object 430, a driver 140 can invoke methods such as IIoQueue::GetStatus to get the status of the queue, or IIoQueue::RetrieveNextRequest to get a request from queue. A driver 140 can also subscribe to notifications on the queue object 40 by registering callback interfaces such as IQueueCallbackRead or IQueueCallbackWrite which are invoked when the application sends a read or write request, respectively.

The base object 440 can be exposed to driver(s) 140 via an IObject interface, and can provide basic functionality that is common across all framework object types. In this example, a framework objects are derived from this root object. Driver(s) 140 can also opt to get notified when an object is about to be destroyed by registering an IObjectCleanup callback interface with the base object 440.

The driver object 410 can be exposed to driver(s) 140 via an IDriver interface, and can be the run time representation of the driver image loaded in the host process. The framework creates a new driver object 440 for each driver 140 loaded in the driver host process. The IDriver interface can be passed to the driver 140 via the IDriverEntry::OnDeviceAdd, which can be the main entry point for the driver 140. The IDriver interface allows the driver 140 to query for the global driver configuration information that provided as part of device installation.

Next, the device object 420 can be exposed to driver(s) via an IDevice interface and can be the run time representation of device on the system. In this example, each device object 420 has a parent driver object. When a new device arrives in the system, the framework component 400 notifies the driver 140 via IDriverEntry::OnDeviceAdd event callback. The driver 140 in this callback configures and creates the device via an IDriver::CreateDevice interface. The driver 140 registers with the device object 440 to get notifications when device(s) arrive and/or leave the system.

A file object can be exposed to driver(s) via an IFile interface and can be the runtime representation of opened device. When an application opens the device via the CreateFile API, the framework component 400 creates a file object to represent that particular “opened” device instance. There can be multiple file objects associated with a single device, one file object for each successful call to CreateFile API. In this example, all I/O operations (e.g., reads and writes) are targeted for a specific file-object instance.

The queue object(s) 430 can represent I/O queues, which are containers for I/O requests and can control the flow of requests into the driver 140. Queue object(s) 430, exposed to drivers via an IIoQueue interface can be associated with device objects 410. In one example, every device has a “default” queue. A driver 140, via IDevice::CreateIoQueue, can create additional queue object(s) 430 on a device object 410. When an I/O request arrives it is placed in the appropriate queue 430. The driver 140 when creating a queue specifies a dispatch model that controls the delivery of requests to the driver 140. The driver 140 registers its callback handlers on the queue object 430 via the CreateIoQueue DDI.

Next, request object(s) can be exposed to driver(s) via an IIoRequest interface and can encapsulate the details of an I/O operation. In this example, all I/O requests are represented as framework request object(s). The reflector 110 notifies the host process when it receives an IRP as result of application operation such as CreateFile or ReadFile. The framework component 400, in response to the reflector 110 notification, constructs a new request object and puts it in the appropriate I/O queue 430. The queue configuration and the locking model chosen by the driver 140 can determine when the request will be presented to the driver 140.

For example, a driver 140 can specify its locking mode as when the device is created. In this example, the driver can choose one of the following locking models specified by_CALLBACK_CONSTRAINT with an enumerated type. For example, the type of constraint (or locking model) chosen can depend on how much parallelism the hardware device can exploit, and how much the driver 140 is willing to handle:

I/O Processing

Queue Dispatch Model

In this model, when I/O requests from application(s) 150 arrive they are placed in the queues 430. How and when the requests are delivered to the driver 140 can depend on the queue configuration and locking model chosen by the driver 140. The I/O queue 430 can also interact with PnP and Power Management sub-system of the framework to hold request(s) in the queue 430 until the device has reached the proper state. An I/O Queue object 430 generally receives the request and tracks it until the driver 140 handles the request, or it is canceled. Depending on configuration, the Queue object 430 can notify the driver 140 of a request through callbacks registered when the queue 430 was created.

In one example, queue dispatch modes include sequential, parallel and/or manual. With the sequential mode, a queue 430 in the processing state controls how it raises event(s) so that a driver 140 is only processing one request at a time. The queue 430 defers any additional requests until the driver 140 has finished processing its current request. When the current request is completed, the queue 430 raises an event to provide the next request.

In one example, the driver 140 can call IIoQueue::RetrieveNextRequest in order to get the next request in the queue 430 as an optimization before completing the current request. In this case, the queue 430 does not automatically send additional requests until all the requests in the driver are completed.

With the parallel mode, a queue 430 in the processing state raises events as soon as I/O is ready for the driver 140. In this case, the driver 140 either starts the I/O and returns an “error I/O pending”, or returns a “hold queue status” to notify the queue 430 that it temporarily can not accept further requests. In this example, the driver 140 is responsible for placing the queue 430 back in the processing state, for example, via IIoQueue:: SetStatus(WdfIoQueueReleaseHold).

Finally, in the manual mode, the queue 430 does not automatically notify the driver 140 when requests arrive at the queue 430. In this example, the driver 140 is responsible for calling IIoQueue::RetrieveNextRequest to retrieve requests manually from the queue 140 when it desires them (e.g., a polling model). In one example, to be notified when a queue 430 has requests to be manually retrieved, a device driver 140 may optionally register for notifications through the IIoQueue::RegisterReadyNotify API.

Completing I/O Requests

In this example, I/O request(s) are eventually completed by one of the driver(s) 140 in the device's driver stack. For example, to complete a request a driver 140 can call IIoRequest::Complete or IIoRequest::CompleteWithInformation.

The driver 140 that completes the request is the driver 140 that determines at least one of the following cases to be true:
The requested I/O operation has finished successfully.
The requested I/O operation was started but failed before it finished.
The requested I/O operation is not supported, or is not valid at the time it was received, and could not be talk to the device.
The requested I/O operation was canceled.

An IIoRequest::CompleteWithInformation method can be employed to pass additional information about the request operation. For example, on a read operation the driver 140 can indicate the actual amount of bytes read.

Forwarding I/O Requests to Lower Drivers

When a driver 140 receives an I/O request that it cannot process, it typically forwards the received request to another driver 140. In this example, the framework component 400 provides asynchronous and synchronous APIs to forward requests—IIoRequest::SynchronousSend and IIoRequest::AsyncSend. In the case of asynchronous request, the driver 140 can optionally provide a callback, that gets invoked when requested is completed by a lower driver 140. This enables the driver 140 to see the result completed by the lower driver 140.

I/O Request Cancel Processing

Requests arrive on queue 430 either from the reflector 110 (via the host process) and/or because the driver 140 has re-queued/forwarded a request to a different queue 430 from its presentation callback handler. For example, a request can be canceled either because the application 150 explicitly requested cancellation (e.g., via IoCancel, IoCancelEx and/or CancelSynchronousIo), and/or because of a system event (e.g., device removal occurred). Driver(s) 140 can be notified of the cancellation request via the previously registered IQueueEventIoCancel::OnCancel callback.

In this example, the request, at any given time, is in one of the following states:
Is in the queue 430 and has never been presented to the driver 140.
Is “in-flight”—it has been presented to the driver 140, but the driver 140 has not yet completed it.

In the case where the request is cancelled before it is presented to the driver 140, the framework component 400 automatically cancels the request. The driver 140's OnCancel event handler is not invoked, even if one is registered.

If the cancel request comes after the request is presented to the driver 140, it is no longer cancelable unless the driver 140 has explicitly called IIoRequest::MarkCancelable, which will fail if the driver 140 has not registered the IQueueCallbackCancel callback interface.

If the request is cancelled before a request is completed, the OnCancel callback is invoked. The driver 140 is responsible for ensuring that the request is completed (e.g., either its OnCancel callback and/or main processing loop), if that is appropriate. In this example, the driver 140 is responsible for ensuring that the request is completed exactly once.

As noted previously, the framework component 400 can include device driver interfaces (DDIs) for the base object 440, driver object 410, device object 420, queue object 430, file object, memory object, and/or request object. The DDIs can be used to communicate status codes. Exemplary DDIs for the framework component follow:

Base Object

In this example, the base object 440 is the root interface for all framework component 400 objects. The driver object 410, device object 420, queue object 430, file object, memory object, and request object derive from it.

Methods

Object::DeleteObject
Description: This routine requests that the object be deleted.
Parameters: None
Results: S_OK on success; Appropriate error code on failure.
Remarks: The device driver can call this function to request that an object be deleted before its associated parent object deletes it. This routine, in effect, requests that framework component 400 release its reference on the object. Upon success, DeleteObject, will cause the OnCleanup callback to be invoked so that circular references can be released, and eventually, when the object's final reference drops to zero, it will be destroyed. If an object allows deleting by the device driver 140, and has an associated parent, there could be race between the device driver 140 calling DeleteObject and associated parent deleting the object. In this example, the framework component 400 handles this race condition and ensures that only one of deletes calls is effective. In this example, not all objects can be deleted by the driver 140, for example, the driver object 410, the device object 420, and/or default queues cannot be deleted by the device driver 140.

IObject::AssignContext
Description: This method allows the driver to associate a context with an instance of an object.
Parameters: pCleanupCallback—supplies the pointer to a IObjectCleanup interface. pContext—supplies the context (e.g., a NULL pointer is valid context).
Return Value: S_OK on success.
Remarks: The driver can opt to get notified when the object becomes invalid by registering IObjectCleanup event callback. The framework component 400 can internally hold a reference to the supplied pCleanupCallback interface while the object is valid, When the object becomes invalid, the framework component 400 can notify the driver via pCleanupCallback. The framework component 400 automatically releases the reference after invoking pCleanupCallback. At any given time, there can be only one context associated with each object instance. An attempt to register additional contexts will fail. Finally, context can be associated only with objects that are in a valid state—for example, an attempt to associate a context with an object that is in the process of deletion fails.

IObject::RetrieveContext
Description: This method retrieves the previously registered context via AssignContext.
Paramater: ppvContext—receives the previously registered context.
Return Value: S_OK on success.

IObject::AcquireLock
Description: This method prevents the framework from invoking callbacks registered by the driver.
Parameters: None
Return: None
Remarks: If the driver configured to use the DeviceLevel or ObjectLevel locking scheme, the framework automatically acquires the “presentation” lock before calling into the driver. IObject::Lock and IObject::Unlock acquires and releases this lock.

Object::ReleaseLock
Description: This method re-enables callbacks into the driver.
Parameters: None
Return: None

Event Callbacks

IObjectCleanup::OnCleanup
Description: This method is called when an object is before the object is destroyed.
Parameters: pObject—The interface of the object about to be destroyed.
Return Value: None
Remarks: The framework invokes this call back as part of an object destruction sequence.
   Driver Object

Callback Constraint

This specifies the serialization (or locking) model for event call backs into the driver 140. Driver(s) 140 can specify the synchronization model for the driver callbacks via the IDeviceInitialize interface.

Event Callbacks

IDriverEntry::OnInitialize
Description: Framework calls this method when the driver image is loaded into the host process. Drivers can perform any global initialization at this time.
Parameters: pDriver—supplies the pointer to interface representing the driver object.
Return: S_OK—Driver indicates the it has completed its global initization.
If driver returns any other HRESULT the framework will not load the driver.

IDriverEntry::OnDeviceAdd
Description: Framework calls this method when new device is detected by the system.
Parameters: pDriver—pointer to the interface of a parent driver to which the device belongs to. pDeviceInit—pointer to the framework provided interface that is used to initialize the newly created device.
Return Value: S_OK on success, or appropriate error code on failure.
Remarks: This is the first call into the driver. The pDeviceInit interface is only valid in the context of the OnDeviceAdd method. If this call fails (returns anything other that S_OK), IDriver::OnDeinitialize will not be called.

IDriverEntry::OnDeinitialize
Description: This is invoked before the driver is unloaded and framework is de-initialized. After this call returns the driver cannot invoke any of the framework interfaces.
Parameters: pDriver—pointer to the interface of the driver to be unloaded.
Return Value: None.
Remarks: The driver will be unloaded after call returns. This call typically happens as a result of removing the device from the system.
   Methods

IDriver::CreateDevice
Description: Create a new object that represents the device.
Parameters: pDeviceInit—Pointer to an interface via which the properties of a newly created device can be updated. pCallbackbackInterface—Driver supplied interface via which the framework discovers the events that the driver is interested in. ppDevice—receives the pointer to the newly created device if the call is successful.
Return Value: Returns S_OK on success, or appropriate error code.
Remarks: The driver will need to call Release( ) on the newly created device, as the interface returned to the driver is ref-counted. In this example, the framework component has it own ref-count on the object.

IDriver::CreateObject
Description: creates a new “basic” object and returns a pointer to the newly creately object. These objects are called as “custom” or “user” object.
Parameter: CallbackbackInterface—pointer to the optional IUnknown interface that the framework uses to QI for the IObjectDispose interface.
ParentObject (optional)—parent of the newly created object. If none is supplied, driver object becomes the default parent. ppObject—receives the pointer to the newly created object.
Return Value: Returns S_OK on success, or appropriate error code.
Remarks: The device driver can use this routine to create a general object for its own use. It can associate context memory, assign a parent and register an IObjectCleanup callback interface so that it can be notified when the parent object is deleted. If no parent object is specified the driver is responsible for explicitly cleaning up this object via the DeleteObject call. If a parent is assigned, this object will get automatically deleted when the parent is deleted.

IDeviceInitialize

_DEVICE_IO_TYPE

```
typedef enum _{——}DEVICE_IO_TYPE
{
  DecideIoUndefined = 0,
  DeviceIoBuffered = 1,
  DeviceIoDirect = 2
    DeviceIoMax
} _DEVICE_IO_TYPE, *P_DEVICE_IO_TYPE;
```

Members: DeviceIoBuffered—specifies that the data will copied from/to the client address space to/from the driver process address space. DeviceIoDirect—specifies that memory pages involved in the transfer will be pinned in memory.

Remarks: The driver should set these properties prior to creating a device object via the IDeviceInitialize::SetIoType interface. In layered device stack, all the device objects must have the same I/O type.

_CALLBACK_CONSTRAINT

```
typedef enum _{——}CALLBACK_CONSTRAINT
{
  None = 0,
  Reserved = 1,
  DeviceLevel = 2,
  ObjectLevel = 3,
}_CALLBACK_CONSTRAINT;
```

Members:
None—No synchronization of callbacks.
DeviceLevel—All callbacks associated with a device are serialized.
ObjectLevel—All callbacks associated with an object are serialized.
Remarks: Note the constraints above only apply for I/O (Open, Close, Read, Write and DeviceIoControl) callbacks and not for PnP/PM notifications.

Properties

IDeviceInitialize::SetExclusive
Description: Set the property that enables the device as an exclusive access device.
Parameter: None
Return Value: S_OK on success; appropriate error code otherwise
Remarks: The framework sets the default value to “not exclusive”. So, the driver will call this function if it requires the device to be an exclusive access device.

IDeviceInitialize::SetIoType
Description: Sets the property that determines how data buffers are moved between the client and the driver.
Parameter: IoType—supplies one of the enumerated values specified by _DEVICE_IO_TYPE.
Return value: S_OK or appropriate error code
Remarks: The default value of this property is DeviceIoBuffered.

IDeviceInitialize::SetLockingConstraint
Description: This sets the concurrency model for callbacks into the driver.
Parameter: LockType—specifies one of values in _CALLBACK_CONSTRAINT enumerated type.
Return: S_OK on success or appropriate error code
Remarks: The default value of this property is DeviceLevel

IDeviceInitialize::GetDevicePropertyStore
Description: Returns device property store through which clients can read and write device properties.
Parameter: ppPropStore—receives the property store interface pointer.
Return Value: S_OK if successful.

Remarks: The caller should call release the property store interface pointer once it is done using the property store. In one example, the following variant types are supported in the property store:

| Variant Type | Write | Read |
|---|---|---|
| VT_BSTR | Writes string value | While reading a string |
| VT_LPWSTR | | value, the value will be |
| VT_LPSTR | | returned as VT_LPWSTR |
| | | regardless of the original |
| | | VT that was used to write |
| | | the value. |
| VT_I1 | Writes an integer value | While reading an integer |
| VT_UI1 | | value, the value will be |
| VT_I2 | | returned as VT_UI4 |
| VT_UI2 | | regardless of the original |
| VT_I4 | | VT that was used to write |
| VT_UI4 | | the value. |
| VT_UINT | | |
| VT_BLOB | To write a binary value | Binary value is returned as |
| | | VT_BLOB |
| VT_VECTOR\| | To write a string array | String Array is returned as |
| VT_LPWSTR | | VT_VECTOR\| |
| | | VT_LPWSTR |

A string containing environment variable(s) is expanded on read.
Device Object

Events

IDeviceStart::OnD0Entry
Description: This callback is invoked when entering D0 power state.
Parameters: pDevice—supplies the interface of the device object that is being “started”. previousState—enum value of the power state the device is coming from
Return: S_OK on success; appropriate error code otherwise.

IDeviceStart::OnD0Exit
Description: This callback is invoked when the device is leaving D0 power state.
Parameters: pDevice—supplies the interface of the device being “stopped”.
previousState—enum value of the power state the device is coming from.
Return: S_OK indicates that the driver has consented to removing the device.

IDeviceStart::OnSurpriseRemoval
Description: This callback is invoked when the device is removed without warning.
Parameters: pDevice—supplies the interface of the device that is to be removed.

Additional interfaces for IDevicePnpSelfManagedIo, IDevicePnpSelfManagedIo::OnSelfManagedIoFlush, IDevicePnpSelfManagedIo::OnSelfManagedIoInit, IDevicePnpSelfManagedIo::OnSelfManagedIoSuspend, IDevicePnpSelfManagedIo::OnSelfManagedIoRestart, IDevicePnpSelfManagedIo::OnSelfManagedIoStop, IDevicePnpInterface::OnAcquireInterface, IDevicePnpInterface::OnReleaseInterface, IDevicePnpHardware::OnPrepareHardware, and/or IDevicePnpHardware::OnReleaseHardware can be provided.

Methods

IDevice::GetDevicePropertyStore
Description: Returns device property store through which clients can read and write device properties.
Parameter: ppPropStore—receives the property store interface pointer.
Return Value: S_OK if successful.
Remarks: The caller should call release the property store interface pointer once it is done using the property store.

IDevice::GetDriver
Description: This method gets the interface to the parent driver object of the device instance.
Parameters: ppDriver—receives pointer to interface of the parent driver.
Return Value: S_OK on success, or appropriate error code.

IDevice::GetDefaultIoTarget
Description: This method gets the interface to I/O target of the device instance.
Parameters: ppTarget—receives pointer to interface to I/O target.
Return Value: S_OK on success, or appropriate error code.

IDevice::GetDefaultIoQueue
Description: This method gets the interface of the default I/O queue for the device.
Parameters: ppQueue—receives pointer to interface to I/O Queue.
Return Value: S_OK on success, or appropriate error code.

IDevice::CreateIoQueue
Description: This method creates a secondary queue for a device.
Arguments: pCallbackInterface—Driver supplied interface via which the framework component 400 discovers the events that the driver subscribes to on this queue. The framework component 400 can specifically QIs for the following interfaces: IQueueCallbackCreateClose, IQueueCallbackRead, IQueueCallbackWrite, and IQueueCallbackDeviceIoControl DispatchType—specifies one enumerated values defined by _IO_QUEUE_DISPATCH_TYPE, bPowerManaged—if TRUE, the framework automatically co-ordinates the queue dispatching with PnP and power state of the device. bAllowZeroLengthRequests—if TRUE, the driver never receives read and write requests that have zero length buffer. The framework automatically completes them successfully on behalf of the driver.
Return: S_OK indicates success.

IDevice::SetDeviceInterface
Description: This method enables or disables the device interface.
Parameters: pDeviceInterfaceGuid—supplies the pointer to the device interface GUID. bEnable—if value is true, the interface is enabled; if value is false, the interface is false.
Return Value: S_OK on success, or appropriate error code.

IDevice::CreateRequest
Description: Creates a framework request object.
Parameters: pIoTarget (optiona)—supplies a handle to an I/O target object or NULL. ppRequest—receives pointer to the interface of the newly created request object.
Return Value: S_OK or appropriate error code

IDevice::GetDeviceName
Description: Gets the name of PDO.
Parameters: pDeviceName—contains a NULL terminated string that represents the underlying kernel mode device name if this buffer non-NULL and the function is successful.
pdwSize—If pDeviceName is NULL, then *pdwSize must be zero. This method return the number characters, including the NULL character, required for the device name.
If pDeviceName buffer is non-NULL, driver supplies the size of the buffer (in characters). The framework returns the size, in characters, of device name string. Return Value: S_OK: if pDevice is not NULL and buffer is large enough to hold the string, including NULL termination character. String is successfully copied into the supplied buffer, and *pdwSize contains the size, in characters, of the string. S_OK: if pDevice is NULL and *pdwSize is set to zero by the driver. The method set *pdwSize to the size, in characters, of the string HRESULT_FROM_WIN32(ERROR_INSUFFICIENT_BUFFER)—indicates that supplied buffer is not NULL and does not have sufficient space to hold the device name. The function fills *pdwSize with the size string. Otherwise, failure codes as appropriate.

IDevice::PostEvent
Description: This method asynchronously notifies any application that has waiting for this event from the drivers.
Parameters: EventGuid—GUID identifying the event. The GUID is determined by the application and the driver, and is opaque to the framework. EventType—indicates the type of event. The supported types are EventBroadcast and EventAutoplay. pbData—buffer containing event data. cbDataSize—size, in bytes, of the data buffer.
Remarks: EventAutoplay cannot be subscribed to by application; it is sent to the operating system for triggering AutoPlay events. The EventBroadcast can be subscribed to by any application. To receive broadcast events, the application must register for notification via the RegisterDeviceNotification API. These events are exposed as DBT_CUSTOMEVENT types to applications.
   Queue

_IO_QUEUE_DISPATCH_TYPE

The IO_QUEUE_DISPATCH_TYPE enumeration identifies the request dispatching types that can be associated with a framework queue object 430.

```
typedef enum _{——}IO_QUEUE_DISPATCH_TYPE
{
  IoQueueDispatchSerial= 1,
  IoQueueDispatchParallel,
  IoQueueDispatchManual,
  IoQueueDispatchMax
} _IO_QUEUE_DISPATCH_TYPE;
```

Members:
IoQueueDispatchSerial: The I/O queue's requests are presented to the driver's I/O queue event callbacks one at a time. The framework component 400 does not deliver the next request until a driver has called IIoRequest::Complete or IRequest::CompleteWithInformation, which completes the current request.
IoQueueDispatchParallel: The framework component 400 presents requests to the driver's I/O queue event callbacks as soon as they are available.
IoQueueDispatchManual: The framework component 400 places requests into the queue, but does not deliver them to the driver. The driver must retrieve requests from the queue by calling IIoQueue::GetRequest.

_REQUEST_TYPE

The _REQUEST_TYPE defines set of constants that defines the type of request object.

| typedef enum _{——}REQUEST_TYPE | |
|---|---|
| { | |
| RequestReserved = 0, | |
| Create | = 1, |
| Cleanup | = 2, |
| Read | = 3, |
| Write | = 4, |
| DeviceIoControl = 5, | |
| Close | = 6, |

```
  //
  //
  RequestMaximum
} _REQUEST_TYPE, *P_REQUEST_TYPE
```

Members:
Create: The request object of this type is sent as a result of an application opening the device via CreateFile API. The framework creates a file object (IFile) and notifies the driver via IQueueCallbackCreateClose::OnCreateFile. The newly created file object represents the HANDLE returned by the CreateFile API. All further operations on this handle, like ReadFile and DeviceIoControl, are sent to this file object.
Cleanup: The request object of this type is sent when the application calls CloseHandle and it results in the closing of the last handle on the framework FileObject associated with target device. The framework notifies the driver via IQueueCallbackCreateClose::OnCleanupFile callback.
Read: The request object of this type is sent when application issues a ReadFile(Ex) call on a FileObject associated with the target device. The framework notifies the driver via the IQueueCallbackRead::OnRead callback.
Write: The request object of this type is sent when application issues a WriteFile(Ex) call on a FileObject associated with the target device. The framework notifies the driver via the IQueueCallbackWrite::OnWrite callback.
DeviceIoControl: The request object of this type is sent when application issues a DeviceIoControl call on a FileObject associated with the target device. The framework notifies the driver of request via IQueueCallbackDeviceIoControl::OnDeviceIoControl callback.
Close: The request object of this type is sent when all the references on a FileObject is closed. The driver is notified via IQueueCallbackCreateClose::OnCloseFile.

_IO_QUEUE_STATUS

The _IO_QUEUE_STATUS enumeration identifies the status of a framework queue object. The enumerators are used as bit masks.

```
typedef enum _{——}IO_QUEUE_STATUS {
  IoQueueAcceptRequests = 0x01,
  IoQueueDispatchRequests = 0x02,
  IoQueueNoRequests = 0x04,
  IoQueueDriverNoRequests = 0x08,
  IoQueuePnpHeld = 0x10
} _IO_QUEUE_STATUS;
```

Members:
IoQueueAcceptRequests: If TRUE the Queue accepts requests via ConfigureDispatching, or from the driver manually forwarding a request via IIoRequest::ForwardRequest. If FALSE, the Queue will complete any requests the “status cancelled” or fail IIoRequest::ForwardRequest with “status busy”.
IoQueueDispatchRequests: If TRUE the Queue is automatically presenting requests to the device driver if its not a IoQueueDispatchManual type. If FALSE the Queue is not automatically dispatching requests to the device driver. The setting of this status does not affect the driver's ability to call GetRequest to manually retrieve requests from the Queue.
IoQueueNoRequests: If TRUE there are no requests in the Queue to be presented to the driver, or returned from GetRequest.
IoQueueDriverNoRequests: If TRUE there are no requests that the driver is operating on that it has received from the Queue from either IIoQueue::OnIoStart or IIoQueue::GetRequest.
IoQueueDriverHeld: If TRUE the driver has called Hold, and must release the Queue with ReleaseHold.
IoQueueDriverPnpHeld: If TRUE an event from the PnP subsystem has suspended processing of requests by the Queue.

_IO_QUEUE_SET_STATUS

Members
IoQueueSetAcceptRequests: Specifies that the framework can add I/O requests to the I/O queue.
IoQueueClearAcceptRequests: Specifies that the framework must not add I/O requests to the I/O queue.
IoQueueSetDispatchRequests: Specifies that the framework can deliver I/O requests from the I/O queue to the driver.
IoQueueClearDispatchRequests: Specifies that the framework must not deliver I/O requests from the I/O queue to the driver.

Event Callbacks

The queue object 430 raises an event when a request is available for the driver 140, or a request that the driver 140 is processing should be cancelled. The I/O queue object raises events in response to following API calls: CreateFile, CloseHandle, ReadFile(Ex), WriteFile(Ex), DeviceIoControl, CancelIo(Ex), and CancelSynchronousIo. The driver 140 can consume these events by registering one or more interfaces described below.

IQueueCallbackCreateClose

OnCreateFile
Description: The framework invokes this method when the application issues the CreateFile API.
Parameters: pIoQueue—Supplies the pointer to the queue interface that the request belongs to. pRequest—Supplies the pointer to the request object's interface that contain the Create request. pFileObject—Supplies the interface to framework file object that is associated with device. This is information is provided for convenience as the driver can get at the file object via IIoRequest:: RetrieveCreateParameters method.
Return Value: None.
Remarks: The framework sends this request when a user application opens the device to perform an I/O operation, such as reading or writing a file.

OnCleanupFile
Description: The framework this method to notify the driver to cancel all I/O request it may have pending. The framework automatically cancels all I/O requests it has pending on behalf of the driver.

OnCloseFile
Description: The framework invokes this callback event when all the handles to the fileobjects are closed.
Parameters: pIoQueue—Supplies the pointer to the queue interface that the request belongs to. pRequest—Supplies the pointer to the request object's interface that contain the Close request. pFileObject—Supplies the interface to framework file object that is associated with the target device.
Return Value: None

IQueueCallbackIoCancel Interface
Description: This is the driver supplied cancel notification callback
Parameters: pRequest—Supplies a handle to a framework request object
Return Value: S_OK on success, or appropriate error code.
Remarks: A driver optionally registers this interface when it calls IDevice::CreateIoQueue.

IQueueCallbackRead Interface
Description: This is the driver supplied interface that gets invoked when the client application issues a read operation via ReadFile(Ex).
Parameters: pQueue—supplies the interface to Queue object that the request belongs to. pRequest—Supplies the interface to the request object.
NumOfBytesToRead—Total size, in bytes, to read.
Return Value: None.
Remarks: A driver registers this optional interface when it calls IDevice::CreateIoQueue. In this example, the OnRead callback receives every _REQUEST_TYPE.Read request from the queue. The driver can use a single IQueueEventIoRead callback for all I/O queues, or different IQueueEventIoRead callbacks for different I/O queues can be supplied.

IQueueCallbackWrite Interface
Description: This is the driver supplied callback interface that gets invoked when the client application issues a write operation via WriteFile(Ex).
Parameters: pQueue—Supplies the interface to queue object that the request belongs to. pRequest—Supplies a handle to a framework request object.
SizeInBytes—Total size, in bytes, of the write buffer.
Return Value: None.
Remarks: A driver registers this optional interface when it calls IDevice::CreateIoQueue. The OnWrite callback receives every RequestWrite request sent to queue. For more information, see I/O Queue Event Callbacks. A single IQueueCallbackWrite interface for all I/O queues can be employed and/or a different IQueueCallbackWrite callback can be used for different I/O queues.

IQueueCallbackDeviceIoControl Interface
Description: This is the driver supplied interface that gets invoked when the client application uses the DeviceIoControl API.
Parameters: pQueue—Supplies the interface to the framework queue object.
pRequest—Supplies the interface to the framework request object.
InputBufferLengthInBytes—Supplies the total size, in bytes, of the input buffer.
OutputBufferLengthInBytes—Supplies the total size, in bytes, of the output buffer. ControlCode—Supplies the driver-defined or system-defined I/O control code (IOCTL) that is associated with the request.
Return Value: None.
Remarks: A driver registers this optional interface when it calls IDevice::CreateIoQueue. The OnDeviceIoControl callback receives every.DeviceIoControl request from the queue. A single IQueueCallbackDeviceControl interface for all I/O queues can be employed and/or a different IQueueCallbackDeviceControl callback can be used for different I/O queues.

IQueueCallbackStatusChange

Methods

IIoQueue::GetDevice
Description: Returns the interface to device that owns the queue.
Parameter: ppDevice—Receives the pointer to the interface of the device, if this call succeeds. Otherwise, *ppDevice is set to NULL.
Return Value: S_OK if successful or appropriate error code.

IIoQueue::ConfigureDispatching
Description: This method enables or disables the framework from automatically forwarding the requests to this queue, if the requests contain the specified RequestType.
Parameters: RequestType—supplies the type of request.
Forward—Supplies a Boolean value. If true, the method enables forwarding. If false, the method disables forwarding of requests with the specified RequestType.
Return Value: S_OK on success, or appropriate error code.
Remarks: This method can called be multiple times with different RequestType values.

IIoQueue::GetStatus
Description: Get the queue status information.
Parameters: pulNumOfRequestsInQueue—Receives the number of I/O requests that are currently in the I/O queue and which have not been delivered to the driver pulNumOfRequestsInDriver—Receives the number of requests that the device driver has accepted from the Queue and has not completed, canceled, or forwarded to another Queue.
pStatusFlag—Receives the status, which is OR'd value of the members of _IO_QUEUE_STATUS.
Return Value: S_OK on success, or appropriate error code.
Remarks: The total number of requests associated with the queue is the sum of the *pulNumOfRequestsInQueue and *pulNumOfRequestsInDriver counts.

IIoQueue::SetStatus
Description: Set the new status information on the queue.
Parameters: NewStatus—Supplies the one the enumerated constants specified in _IO_QUEUE_STATUS.
Return Value: S_OK on success, or appropriate error code.
Remarks: A driver can call SetStatus to enable or disable either of the following:

Adding I/O Requests to an I/O Queue.

Delivering I/O requests from the queue to the driver.
Calling SetStatus does not affect I/O requests that have already been delivered to the driver. All such requests must be completed or canceled by a driver in the device stack. To determine the current state of an I/O queue, the driver can call GetStatus.

IIoQueue::RetreiveNextRequest
Description: This method retrieves request from the I/O queue.
Parameter: ppRequest—Receives an interface to a framework request object, or receives NULL if the queue is empty or if a specified request was not found.
Return Value: S_OK if successful or appropriate error code.
Remarks: If a driver configures an I/O queue for manual dispatching of I/O requests, the driver calls this method to obtain requests from the queue.

IIoQueue::RetrieveRequestByFileObject
Description: This method retrieves the next I/O request whose file object matches the supplied input file object. If there are multiple I/O requests that matches the first one in the queue is returned.
Parameters: pFile—supplies the interface to the file object to match in the request.
ppRequest—receives the pointer to the interface of the request object if one is found. Otherwise this is NULL.
Return Value: S_OK—success.

IIoQueue::Start
Description: This method enables the queue to start receiving and delivering the new I/O requests.
Parameters: None
Return Value: None

IIoQueue::Stop
Description: This method prevents the queue from delivering new I/O requests to the driver, but queue continues to accept requests from the application.
Parameters: StopComplete—caller supplied callback that will be invoked by the framework when all the outstanding requests, if any, in the driver is completed.
Return Value: S_OK on success, or appropriate error code.

IIoQueue::StopSynchronously
Description: The StopSynchronously method prevents the I/O queue from delivering new I/O requests to the driver but still allows the I/O queue to accept requests from applications.
Parameters: None
Return Value: None

IIoQueue::Drain
Description: This method directs the framework component 400 to send all I/O requests in the I/O queue to the driver.
Parameters: pDrainComplete—Pointer to the IQueueCallbackStatusChange interface whose method is called after it sends all I/O requests in the I/O queue to the driver.
Return Value: None

IIoQueue::DrainSynchronously
Description: This method directs the framework component 400 to send all I/O requests in the I/O queue to the driver.
Parameters: None
Return Value: None

IIoQueue::Purge
Description: This method directs the framework component 400 to remove all I/O requests from the I/O queue.
Parameters: pPurgeComplete—Pointer to the IQueueCallbackStatusChange interface whose method called after removal of all I/O requests from the I/O queue.
Return Value: None

IIoQueue::PurgeSynchronously
Description: This method directs the framework component 400 to remove all I/O requests from the I/O queue.
Parameters: None
Return Value: None
   File Object

Object Methods

IFile::GetDevice
Description: Get the device object to which the file object associated to.
Parameters: ppDevice—receives the pointer to the interface of the device object.
Return Value: S_OK on success, or appropriate error code.

IFile::GetFileName
Description: Gets the full file name.
Parameters: pFileName—receives a pointer to the file name.
pdwFileNameLenght—the driver supplies the size of the buffer. If the return value is S_OK, this contains the size, in characters, of file name.
Return Value: S_OK on success, or appropriate error code.
   Memory Object

IMemory::CopyFromMemory
Description: This routine safely copies the data from the source buffer and prevents overruns resulting from the copy operation.
Parameters: Source: supplies a IMemory interface which becomes the sources of the copy operation. SourceOffset: If not NULL, the BufferOffset parameter indicates the offset into Source to start the copy from. The BufferLength parameter is ignored and must be set to zero since the length of copy is dictated the current buffer (destination) length and offset combination.
Return Value: S_OK, if successful.

IMemory::CopyToBuffer
Description: This routine safely copies data from the memory object to supplied input TargetBuffer.
Parameters: SourceOffset—supplies the offset in the memory object to start the copy from. TargetBuffer—supplies the Target buffer to copy into.
NumOfBytesToCopy—supplies the number of bytes to copy.
Return value: S_OK on success.

IMemory::CopyFromBuffer
Description: This routine safely copies data from the supplied input buffer, Source Buffer, to the memory object.
Parameters: DestOffset—supplies the start of offset in the memory object for the copy operation. Sourcebuffer—supplies the buffer from which data is copied. NumOfBytesToCopyFrom—Number of bytes to copy from supplied source buffer.

IMemory::GetDataBuffer
Description: This routine returns the data buffer associated with the memory object
Parameters: BufferSize—receives the size of buffer.
Return Value: Data buffer associated with memory object.

IMemory::GetSize
Description: This routine returns the size of the memory buffer.
Parameter: None
Return Value: Size, in bytes, of the data buffer associated with the memory object.
   Request Object

Event Callbacks
interface IRequestCompletionCallback:IUnknown

Methods

IIoRequestResult Interface

IIoRequest::CompleteWithInformation
Description: This method completes a request with supplied status value.
Parameters: CompletionStatus—status to complete the request with.
Information—driver supplied additional information related to the I/O operation. For read, write and device I/O control operations, this can be set to the number of bytes transferred.
Return Value: S_OK—on success

IIoRequest::Complete
Description: Same as CompleteWithlnfomoration, except Information is zero in this case.

IIoRequest::GetType
Description: Determines the operation-code (or type) of the request.
Return Value: Returns type of the request

IIoRequest::RetrieveCreateParameters
Description: Retrieves the request parameters for the Create type request.
Parameters: pFileObject—represents the file object that represents this create request.
Return Value: S_OK on success

IIoRequest::RetrieveCloseParameters
Description: Retrieves the request parameters for the Close type request.
Parameters: pFileObject—represents the file object that represents this close request.
Return Value: S_OK on success

IIoRequest::RetrieveReadParameters
Description: Retrieves the request parameters for the Read type request.
Parameters: ppMemory—receives a pointer to a framework memory object which represents the read buffer in the request. pSizeInBytes—receives the total size, in bytes, of the read buffer. pullOffset—pointer that receives the offset in the read buffer for starting the transfer. Applications specify this value in the “Offset” and OffsetHigh” members of the OVERLAPPED I/O structure that is passed in ReadFile(Ex). pulKey—recives a key that can be used by the driver to sort I/O request(s) (e.g., in a driver determined fashion).
Return Value: S_OK if successful, or appropriate error.
Remarks: This call fails if the request type is not Read.

IIoRequest::RetrieveWriteParameters
Description: Retrieves the request parameters for the Write type request.
Parameters: ppMemory—receives a pointer to a framework memory object which represents the write buffer in the request. pSizeInBytes—receives the total size, in bytes, of the write buffer. pullOffset—pointer that receives the offset in the buffer for starting the write operation. Applications specify this value in the “Offset” and OffsetHigh” members of the OVERLAPPED I/O structure that is passed in Write(Ex). pulKey—recives a key that can used by the driver to sort i/o requests in a driver determined fashion.
Return Value: S_OK if successful, or appropriate error.
Remarks: This call fails if the request type is not Write.

IIoRequest::RetrieveDeviceIoControlParameters
Description: Retrieves the request parameters associated with a
DeviceIoControl request.
Parameters: ppControlCode—recives the device IOCTRL. ppInputMemory—receives a pointer to the input memory object that wraps the underlying input data buffer. pInBufferSize—receives the size, in bytes, of the input buffer. ppOutMemory—receives a pointer to the output memory object that wraps the underlying output data buffer. pOutBufferSize—receives the size, in bytes, of the output buffer.
Return Value: S_OK if successful, or appropriate error.
Remarks: This call fails if the request type is not DeviceIoControl

IIoRequest::RetrieveOutputMemory
Description: This routine gets the memory object that represents the output buffer in the request.
Parameter: ppOutputMemory—receives a ref-counted IMemory interface to memory object that the driver must release.
Return Value: S_OK—success or appropriate error status.
Remarks: The device driver must call IMemory::Release prior to completing the request. The underlying memory object is freed when the request is completed.

IIoRequest::RetrieveInputMemory
Description: This routine gets the memory object that represents the input buffer in the request.
Parameter: ppInputMemory—receives a ref-counted IMemory interface to memory object that driver must release.
Return Value: S_OK—success or appropriate error status.
Remarks: The device driver must call IMemory::Release prior to completing the request. The underlying memory object is freed when the request is completed.

IIoRequest::MarkCancelable
Description: This method enables or disables canceling of the request.
Return Value: S_OK—if the operation is succeeds, appropriate error code returned otherwise,

IIoRequest::UnmarkCancelable
Description: This method disables the canceling of the I/O request.

IIoRequest::CancelSentRequest
Description: Cancels the I/O request.
Return Value: TRUE indicates the request was cancelled.

IIoRequest::ForwardToQueue
Description: This method forwards (re-queues) the I/O request that the framework has delivered to the driver.
Parameters: pDestQueue—supplies the interface to the destination queue object.
Return Value: S_OK—if the operation is succeeds.
Remarks: In this example, the driver cannot re-queue the request to the same queue it came from. Also, this method cannot re-queue a request that was obtained by calling IIoQueue::GetRequest.

IIoRequest::AsyncSend
Description: This method sends the request to specified I/O target asynchronously.
Parameters: ploTarget—supplies the interface to a I/O Target, which typically is a lower driver in the stack. pCallback—callback that gets invoked when the requested is completed.
pContext—pointer to the driver-specific context information.
Returns: S_OK—indicates the successful sending of request to the target. However, this does not imply that the request sent has been completed. Remarks: The AsyncSend is an asynchronous operation that will return immediately. When the request gets completed the callback, if registered, is invoked. The driver can get results of the completed request by calling IIoRequestResut::GetQueuedResults.

IIoRequest::SynchronousSend
Description: This method sends the request to specified I/O target and waits until the request is completed.
Parameters: ploTarget—supplies the interface to a I/O Target, which typically is a lower driver in the stack. TimeoutInMilliseconds—the framework automatically cancels the request when the timeout expires.
Returns: S_OK on successful completion of the request.

IIoRequest::GetFileObject
Description: Returns the file object associated with the request.
Parameters: ppFileObject—receives the interface to the file object. NULL is valid return value.
Return Value: S_OK—if successful

IWDIoRequest::CopyCurrentStackLocationToNext

IIoRequest::GetRequestorProcessId
Description: This routine returns the process id of the application that initiated the I/O request.
Parameters: None
Return Value: Process Id.

It is to be appreciated that the architecture 100, the reflector 110, the driver manager 120, the host process 130, the user-mode device driver(s) 140, the application 150, the driver manager control object 160, the host process control object 170, the architecture 200, the reflector 210, the up device object 220, the down device object 230, the kernel driver 240, the host process 300, the host runtime component 310, the framework component 320, the device stack object 330, the message handler 340, the user mode IRPs store 350, the file object 360, the framework component 400, the driver object 410, the device object 420, the queue object 430, and/or the base object 440 can be computer components as that term is defined herein. A

Those skilled in the art will recognize that the interfaces discuss herein are merely exemplary of interfaces which can be employed with the subject invention. Thus, it is to be appreciated that any type of interface suitable for carrying out the subject invention can be employed and all such types of interface are intended to fall within the scope of the hereto appended claims.

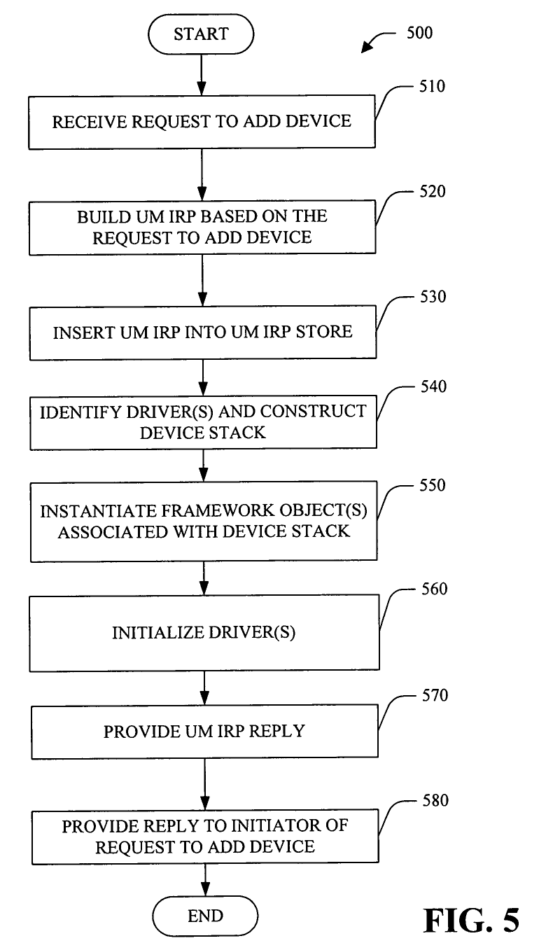

Turning briefly to FIG. 5, a methodology that may be implemented in accordance with the subject invention are illustrated. While, for purposes of simplicity of explanation, the methodologies are shown and described as a series of blocks, it is to be understood and appreciated that the subject invention is not limited by the order of the blocks, as some blocks may, in accordance with the subject invention, occur in different orders and/or concurrently with other blocks from that shown and described herein. Moreover, not all illustrated blocks may be required to implement the methodology in accordance with the subject invention.

The subject invention may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Referring to FIG. 5, a method of adding a device in a user-mode device driver architecture 500 in accordance with an aspect of the subject invention is illustrated. At 510, a request to add a device is received, for example, from a reflector. At 520, a user mode (UM) IRP is built based upon the add device request. At 530, the UM IRP is inserted into the UM IRP store.

Next, at 540 driver(s) associated with the UM IRP are identified and a device stack is constructed. At 550, framework object(s) associated with the device stack are instantiated. At 560, the driver(s) are initialized. At 570, a UM IRP reply is provided. At 580, a reply is provided to the initiator of the add device request.

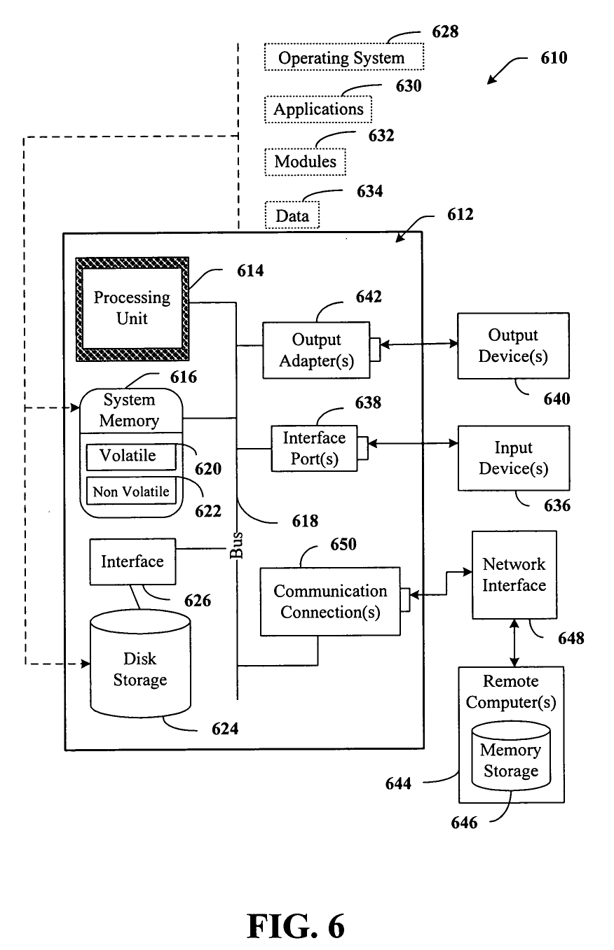

In order to provide additional context for various aspects of the subject invention, FIG. 6 and the following discussion are intended to provide a brief, general description of a suitable operating environment 610 in which various aspects of the subject invention may be implemented. While the subject invention is described in the general context of computer-executable instructions, such as program modules, executed by one or more computers or other devices, those skilled in the art will recognize that the subject invention can also be implemented in combination with other program modules and/or as a combination of hardware and software. Generally, however, program modules include routines, programs, objects, components, data structures, etc. that perform particular tasks or implement particular data types. The operating environment 610 is only one example of a suitable operating environment and is not intended to suggest any limitation as to the scope of use or functionality of the subject invention. Other well known computer systems, environments, and/or configurations that may be suitable for use with the subject invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 6, an exemplary environment 610 for implementing various aspects of the subject invention includes a computer 612. The computer 612 includes a processing unit 614, a system memory 616, and a system bus 618. The system bus 618 couples system components including, but not limited to, the system memory 616 to the processing unit 614. The processing unit 614 can be any of various available processors. Dual microprocessors and other multiprocessor architectures also can be employed as the processing unit 614.

The system bus 618 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 616 includes volatile memory 620 and nonvolatile memory 622. The basic input/output system (BIOS), containing the basic routines to transfer information between elements within the computer 612, such as during start-up, is stored in nonvolatile memory 622. By way of illustration, and not limitation, nonvolatile memory 622 can include read only memory (ROM), programmable ROM (PROM), electrically programmable ROM (EPROM), electrically erasable ROM (EEPROM), or flash memory. Volatile memory 620 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 612 also includes removable/nonremovable, volatile/nonvolatile computer storage media. FIG. 6 illustrates, for example a disk storage 624. Disk storage 624 includes, but is not limited to, devices like a magnetic disk drive, floppy disk drive, tape drive, Jaz drive, Zip drive, LS-100 drive, flash memory card, or memory stick. In addition, disk storage 624 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 624 to the system bus 618, a removable or non-removable interface is typically used such as interface 626.

It is to be appreciated that FIG. 6 describes software that acts as an intermediary between users and the basic computer resources described in suitable operating environment 610. Such software includes an operating system 628. Operating system 628, which can be stored on disk storage 624, acts to control and allocate resources of the computer system 612. System applications 630 take advantage of the management of resources by operating system 628 through program modules 632 and program data 634 stored either in system memory 616 or on disk storage 624. It is to be appreciated that the subject invention can be implemented with various operating systems or combinations of operating systems.

A user enters commands or information into the computer 612 through input device(s) 636. Input devices 636 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 614 through the system bus 618 via interface port(s) 638. Interface port(s) 638 include, for example, a serial port, a parallel port, a game port, and a universal serial bus (USB). Output device(s) 640 use some of the same type of ports as input device(s) 636. Thus, for example, a USB port may be used to provide input to computer 612, and to output information from computer 612 to an output device 640. Output adapter 642 is provided to illustrate that there are some output devices 640 like monitors, speakers, and printers among other output devices 640 that require special adapters. The output adapters 642 include, by way of illustration and not limitation, video and sound cards that provide a means of connection between the output device 640 and the system bus 618. It should be noted that other devices and/or systems of devices provide both input and output capabilities such as remote computer(s) 644.

Computer 612 can operate in a networked environment using logical connections to one or more remote computers, such as remote computer(s) 644. The remote computer(s) 644 can be a personal computer, a server, a router, a network PC, a workstation, a microprocessor based appliance, a peer device or other common network node and the like, and typically includes many or all of the elements described relative to computer 612. For purposes of brevity, only a memory storage device 646 is illustrated with remote computer(s) 644. Remote computer(s) 644 is logically connected to computer 612 through a network interface 648 and then physically connected via communication connection 650. Network interface 648 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 650 refers to the hardware/software employed to connect the network interface 648 to the bus 618. While communication connection 650 is shown for illustrative clarity inside computer 612, it can also be external to computer 612. The hardware/software necessary for connection to the network interface 648 includes, for exemplary purposes only, internal and external technologies such as, modems including regular telephone grade modems, cable modems and DSL modems, ISDN adapters, and Ethernet cards.

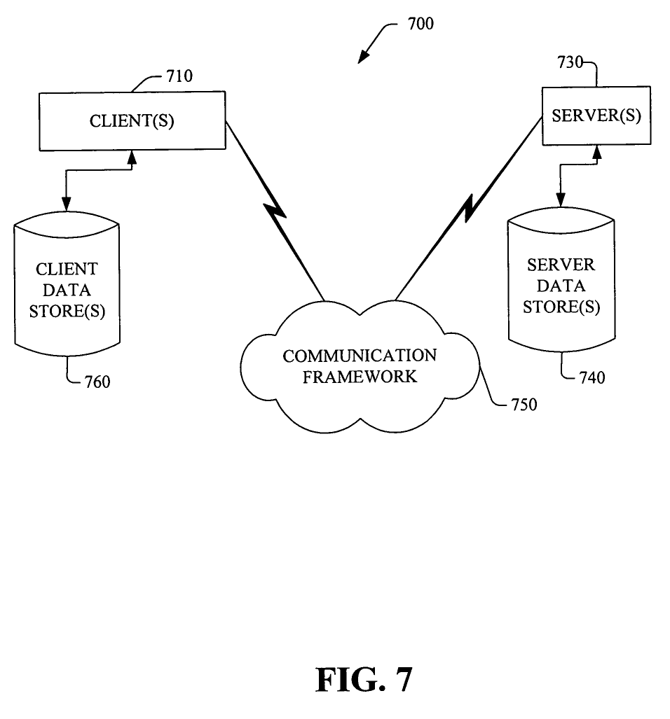

FIG. 7 is a schematic block diagram of a sample-computing environment 700 with which the present invention can interact. The system 700 includes one or more client(s) 710. The client(s) 710 can be hardware and/or software (e.g., threads, processes, computing devices). The system 700 also includes one or more server(s) 730. The server(s) 730 can also be hardware and/or software (e.g., threads, processes, computing devices). The servers 730 can house threads to perform transformations by employing the present invention, for example. One possible communication between a client 710 and a server 730 can be in the form of a data packet adapted to be transmitted between two or more computer processes. The system 700 includes a communication framework 750 that can be employed to facilitate communications between the client(s) 710 and the server(s) 730. The client(s) 710 are operably connected to one or more client data store(s) 760 that can be employed to store information local to the client(s) 710. Similarly, the server(s) 730 are operably connected to one or more server data store(s) 740 that can be employed to store information local to the servers 730.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A host process component of a user-mode device driver architecture comprising:
a message handler that receives a message from a reflector in kernel mode, generates a user mode IRP comprising the message, and, stores the user mode IRP in a user mode IRP store; and,
a device stack object that identifies a user-mode device driver associated with a device, constructs a device stack associated with the device, and, instantiates framework objects associated with the device stack, the framework objects facilitates communication with the user mode device driver.

2. The host process component of claim 1, the message exchanged between the reflector and the message handler comprising an ALPC message.

3. The host process component of claim 1, the message associated with a corresponding I/O request from an application.

4. The host process component of claim 1, the reflector and message handler communicate via a plurality of channels.

5. The host process component of claim 1, the framework objects raise events to the user-mode device drivers.

6. The host process component of claim 1, the framework objects comprising a queue object that facilitates communication between the host process and the user-mode device driver.

7. The host process component of claim 6, the queue object employs a sequential dispatch mode.

8. The host process component of claim 6, the queue object employs a parallel dispatch mode.

9. The host process component of claim 6, the queue object employs an upon request from the user-mode device driver dispatch mode.

10. The host process component of claim 6, the queue object created in response to a request from the user-mode device driver.

11. The host process component of claim 1, the framework objects comprising a device object exposed to the user-mode device driver, the device object is a runtime representation of a device.

12. The host process component of claim 11, the user-mode device driver registers with the device object to receive notifications.

13. The host process component of claim 1, the framework objects comprising a driver object exposed to the user-mode device driver, the driver object is a runtime representation of the user-mode device driver in the host process component.

14. The host process component of claim 1, the framework objects comprising a base object exposed to the user-mode device driver, the base object provides basic functionality common across a plurality of framework objects.

15. The host process component of claim 1, the framework objects comprising a file object exposed to the user-mode device driver, the file object is a runtime representation of an opened device.

16. The host process component of claim 1, the framework objects comprising a request object which encapsulates details of an I/O operation.

17. A method of adding a device in a user-mode device driver architecture comprising:
building a user mode IRP based on a request to add a device;
inserting the user mode IRP into a user mode IRP store;
identifying drivers associated with the user mode IRP;
constructing a device stack associated with the driver identified;
instantiating framework objects associated with the device stack; and,
initializing the identified drivers.

18. The method of claim 17, further comprising at least one of:
providing a user mode IRP reply; and,
providing a reply to an initiator of the add device request.

19. A computer readable medium having stored thereon computer executable instructions for carrying out the method of claim 17.

20. A data packet transmitted between two or more computer components that facilitates communication between a host process and a user-mode device driver, the data packet comprising:
a user mode IRP corresponding to an I/O request from an application, the user mode IRP message generated by the host process in user mode.
